(19) United States
(12) Patent Application Publication
(10) Pub. No.: US 2026/0180807 A1
(43) Pub. Date: Jun. 25, 2026

(54) SECURITY CONTROL METHOD AND APPARATUS FOR POWER COMMUNICATION NETWORK, CENTRAL COORDINATOR (CCO), AND NODE

(71) Applicant: BEIJING SMARTCHIP MICROELECTRONICS TECHNOLOGY COMPANY LIMITED, Beijing (CN)

(72) Inventors: Dongyan Zhao, Beijing (CN); Kunpeng Xu, Beijing (CN); Xiaohui Zhang, Beijing (CN); Zheng Li, Beijing (CN); Dan Luo, Beijing (CN); Deyong Xiao, Beijing (CN); Guanqiang Cao, Beijing (CN); Fuyu Pei, Beijing (CN); Pin Chen, Beijing (CN)

(21) Appl. No.: 18/836,009

(22) PCT Filed: Mar. 11, 2024
(86) PCT No.: PCT/CN2024/081051

§ 371 Date: Aug. 6, 2024

(30) Foreign Application Priority Data
Jun. 29, 2023 (CN) 202310780475.6

(51) Int. Cl. H04L 9/32; H04L 9/08

(52) U.S. Cl. CPC H04L 9/3247; H04L 9/0819

(57) ABSTRACT

Provided are a security control method and apparatus for a power communication network, a central coordinator (CCO), and a node. A CCO initially sets a security mode of a power communication network to an unencrypted mode. In the unencrypted mode, a first network access request of a station (STA) is received, where the first network access request carries a communication type of the STA. Whether to enable an encrypted mode is determined based on a communication type of each STA in the power communication network. When there is a multi-mode node in the power communication network, the security mode of the power communication network is set to the encrypted mode. This realizes compatibility between the single-mode node and the multi-mode node, achieves security control, improves secure communication between the CCO and the STA, and implements a direct secure anti-eavesdropping solution between the CCO and the STA.

### TECHNICAL FIELD

Embodiments of the present disclosure relate to the technical field of power communication, and in particular, to a security control method and apparatus for a power communication network, a central coordinator (CCO), and a node.

### BACKGROUND

An electricity consumption information collection system of power communication usually includes a main station (STA) and an electricity meter. The main STA can be configured with a central coordinator (CCO), and the electricity meter can be configured with a STA. In this way, data exchange between the main STA and the electricity meter is supported through the CCO and the STA.

In related technologies, high-speed power line communication (HPLC) and high-speed radio frequency (HRF) communication are main communication modes for the electricity consumption information collection system of the power communication. However, security of communication between the CCO and the STA needs to be improved.

### SUMMARY

The present disclosure is intended to resolve at least one of the technical problems existing in the prior art. In view of this, the present disclosure provides a security control method and apparatus for a power communication network, a CCO, and a node.

The present disclosure provides a security control method for a power communication network, which is applied to a CCO included in the power communication network. The security control method includes: setting a security mode of the power communication network to an unencrypted mode; obtaining a communication type of a STA upon receiving a first network access request sent by the STA; and setting the security mode of the power communication network to an encrypted mode when determining, based on the communication type of the STA and a corresponding node type list of the power communication network, that there is a multi-mode node in the power communication network, where the node type list stores a communication type of a STA that has been connected to the power communication network.

The present disclosure provides a security control method for a power communication network, which is applied to a STA included in the power communication network. The security control method includes: sending a first network access request to a CCO included in the power communication network when a security mode of the power communication network is an unencrypted mode, where the first network access request carries a communication type of the STA; the first network access request is used to instruct the CCO to set the security mode of the power communication network, where when it is determined based on the communication type of the STA and a corresponding node type list of the power communication network that there is a multi-mode node in the power communication network, the CCO sets the security mode to an encrypted mode, where the node type list stores a communication type of a STA that has been connected to the power communication network.

The present disclosure provides a security control apparatus for a power communication network, which is applied to a CCO included in the power communication network. The security control apparatus includes:
a security mode setting module configured to set a security mode of the power communication network to an unencrypted mode;
a communication type obtaining module configured to obtain a communication type of a STA upon receiving a first network access request sent by the STA; and
an encryption mode setting module configured to set the security mode of the power communication network to an encrypted mode when it is determined based on the communication type of the STA and a corresponding node type list of the power communication network that there is a multi-mode node in the power communication network, where the node type list stores a communication type of a STA that has been connected to the power communication network.

The present disclosure provides a security control apparatus for a power communication network, which is applied to a STA included in the power communication network. The security control apparatus includes:
a network access request sending module configured to send a first network access request to a CCO included in the power communication network when a security mode of the power communication network is an unencrypted mode, where the first network access request carries a communication type of the STA; the first network access request is used to instruct the CCO to set the security mode of the power communication network, where when it is determined based on the communication type of the STA and a corresponding node type list of the power communication network that there is a multi-mode node in the power communication network, the CCO sets the security mode to an encrypted mode, where the node type list stores a communication type of a STA that has been connected to the power communication network.

The present disclosure provides a CCO, including a transceiver, a processor, and a memory, where the memory is configured to store a computer program, and the processor is configured to call the computer program to perform the method applied to the CCO in any of the above embodiments.

The present disclosure provides a STA, including a transceiver, a processor, and a memory, where the memory is configured to store a computer program, and the processor is configured to call the computer program to perform the method applied to the STA in any of the above embodiments.

The present disclosure provides a computer-readable storage medium, where the computer-readable storage medium stores a computer program, and the computer program is executed by a processor to implement the method in any of the above embodiments.

In the present disclosure, a CCO initially sets a security mode of a power communication network to an unencrypted mode. In the unencrypted mode, a first network access request of a STA is received, where the first network access request carries a communication type of the STA. Whether to enable an encrypted mode is determined based on a communication type of each STA in the power communication network. When there is a multi-mode node in the power communication network, the security mode of the power communication network is set to the encrypted mode. This realizes compatibility between a single-mode node and the multi-mode node, achieves security control based on normal communication, improves secure communication between the CCO and the STA, reduces a probability of an eavesdropping event, and implements a direct secure anti-eavesdropping solution between the CCO and the STA.

A part of additional aspects and advantages of the present disclosure is provided in the following descriptions, and the part will become apparent from the following descriptions, or may be learned from the practice of the present disclosure.

### BRIEF DESCRIPTION OF THE DRAWINGS

FIG. 1 is a schematic flowchart of implementing a security policy according to an implementation of the specification;

FIG. 2a is a schematic flowchart of identity authentication for secure network access of a dual-mode node according to an implementation of the specification;

FIG. 2b is a schematic flowchart of identity authentication for secure network access of a dual-mode node according to an implementation of the specification;

FIG. 3 is a schematic diagram of verifying validity of a certificate according to an implementation of the specification;

FIG. 4a is a schematic diagram of sending a CEK update message by a CCO according to an implementation of the specification;

FIG. 4b is a schematic flowchart of sending a CEK request message by a STA according to an implementation of the specification;

FIG. 4c is a schematic flowchart of sending a CEK confirmation message by a CCO according to an implementation of the specification;

FIG. 5a is a schematic diagram of a data structure corresponding to a hierarchical structure according to an implementation of the specification;

FIG. 5b is a schematic flowchart of data encryption and transmission according to an implementation of the specification;

FIG. 5c is a schematic flowchart of data decryption and reception according to an implementation of the specification;

FIG. 6 is a schematic flowchart of a security control method according to an implementation of the specification;

FIG. 7 is a schematic flowchart of a security control method according to another implementation of the specification;

FIG. 8 is a schematic flowchart of whether to send a key according to an implementation of the specification;

FIG. 9 is a schematic flowchart of a security control method according to still another implementation of the specification;

FIG. 10 is a schematic flowchart of sending a key request message to a CCO according to an implementation of the specification; and

FIG. 11 is a schematic flowchart of a security control apparatus according to an implementation of the specification.

### DETAILED DESCRIPTION

The embodiments of the present disclosure are described below in detail. Examples of the embodiments are shown in the accompanying drawings. The same or similar numerals represent the same or similar elements or elements having the same or similar functions throughout the specification. The embodiments described below with reference to the accompanying drawings are illustrative for explaining the present disclosure and are not to be construed as limiting the present disclosure.

In related technologies, an electricity consumption information collection system of power communication mainly relies on embedded secure access module (ESAM) encryption to prevent an external device from actively reading electricity meter data. A main body of the electricity consumption information collection system is an electricity meter and a main STA, and business layer encryption is used. In a construction process of the electricity consumption information collection system, only secure communication between the main STA and the electricity meter is considered. For example, for interaction similar to fee control, the main STA directly interacts with the electricity meter, and a concentrator is responsible for transparent forwarding. Therefore, for current collection tasks such as daily freezing, the ESAM encryption can be achieved only through cooperation with some terminals, and the ESAM encryption cannot be achieved for some terminals.

In the related technologies, the electricity consumption information collection system adopts two communication modes: HPLC and HRF communication. A power line communication (PLC) technology is a communication technology that uses a power line as a communication medium for data transmission. An HRF communication technology is a broadband micro-power wireless communication technology. In the related technologies, a security policy is not added to a networking mode of a PLC system based on at least these two communication modes. Therefore, in the related technologies, there is a certain eavesdropping risk when a CCO communicates directly with a STA.

Specifically, there is both a single-mode node (also referred to as a single-mode module) not supporting a security encryption function and a multi-mode node (also referred to as a multi-mode module) supporting the security encryption function in a communication module. To ensure that security control can be achieved based on normal communication when the two modules coexist in a network, it is necessary to provide an anti-eavesdropping secure communication mode for the direct communication between the CCO and the STA. In this way, secure communication between the CCO and the STA is achieved between terminals, thereby reducing a probability of an eavesdropping event during normal communication between the CCO and the STA. It should be noted that the multi-mode node may be a node based on two communication modes (such as a dual-mode node), or a node based on a plurality of communication modes. A communication mode of the multi-mode node may include at least two communication modes: the HPLC and the HRF communication, or may include at least one of an Ethernet, a mobile link, a Bluetooth link, a wireless fidelity (WIFI) link, a LoRa link, a ZigBee link, and an Rs-485 link.

The dual-mode node based on the HPLC and the HRF communication is taken as an example to illustrate an example scenario. In an electricity consumption information collection system of power communication based on the HPLC and the HRF communication, in the related technologies, the security policy is not added to a networking mode of the communication module. If it is required to add the security policy to the electricity consumption information collection system of the power communication, following issues need to be considered:

1) Compatibility between the single-mode node not supporting the security encryption function and the dual-mode node supporting the security encryption function.

2) Validity verification of a certificate issued by a third party (such as a designated measurement center).

3) Identity authentication process of secure network access of the communication module.

4) Maintenance and update of a key used for encryption.

5) How to incorporate encryption and decryption in a business data transceiving process.

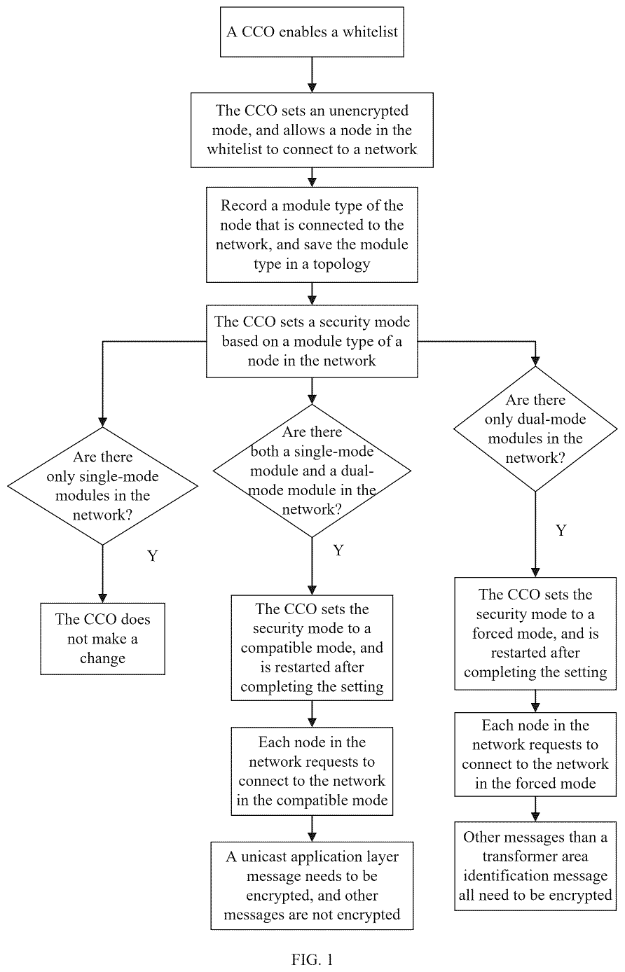

In consideration of the above issues, an implementation of the specification provides a security control method for a power communication network, where the power communication network includes a CCO. Referring to FIG. 1, after being powered on, the CCO enables a whitelist of the power communication network. The CCO sets a security mode of the power communication network to an unencrypted mode to allow a STA in the whitelist to connect to the power communication network. During network access, any STA sends a first network access request to the CCO, and the CCO receives the first network access request. The first network access request carries a communication type of the any STA. The CCO corresponds to a topology list of the power communication network, and records the communication type of the any STA in the topology list. By analogy, the topology list stores a communication type of a STA that has been connected to the power communication network. Based on communication types of STAs recorded in the topology list, different security modes are selected for networking.

Still referring to FIG. 1, when the communication types of the STAs recorded in the topology list are all single-mode nodes, the security mode of the CCO remains unchanged, that is, is still the unencrypted mode. When there is a dual-mode node in the communication types of the STAs recorded in the topology list, the CCO sets the security mode of the power communication network to an encrypted mode.

Still referring to FIG. 1, where there is both a single-mode node and the dual-mode node in the communication types of the STAs recorded in the topology list, the CCO sets the security mode of the power communication network to a compatible mode. After setting the security mode of the power communication network to the compatible mode, the CCO is restarted, and the STA in the power communication network requests network access in the compatible mode. In the compatible mode, an application layer message transmitted by the dual-mode node needs to be encrypted. For example, a STA that has not been connected to the power communication network receives a beacon sent by the CCO, and determines, based on the beacon, that a current security mode is the compatible mode. Whether communication data needs to be encrypted is determined. For the single-mode node, the data does not need to be encrypted, and network access can be carried out based on a network access process of the single-mode node. For example, a single-mode node X sends a network access request to the CCO, where the network access request carries a MAC address of the single-mode node X. The CCO determines whether the MAC address of single-mode node X exists in the whitelist. If the MAC address of the single-mode node X exists in the whitelist, the single-mode node X is allowed to connect to the power communication network. For the dual-mode node, the application layer message transmitted by the dual-mode node needs to be encrypted. Therefore, in a network access process of the dual-mode node, a customer master key (CMK) and a contents encrypting key (CEK) need to be securely exchanged.

Still referring to FIG. 1, when the communication types of the STAs recorded in the topology list are all dual-mode nodes, the CCO sets the security mode of the power communication network to a forced mode. In the forced mode, other messages than a transformer area identification message need to be encrypted.

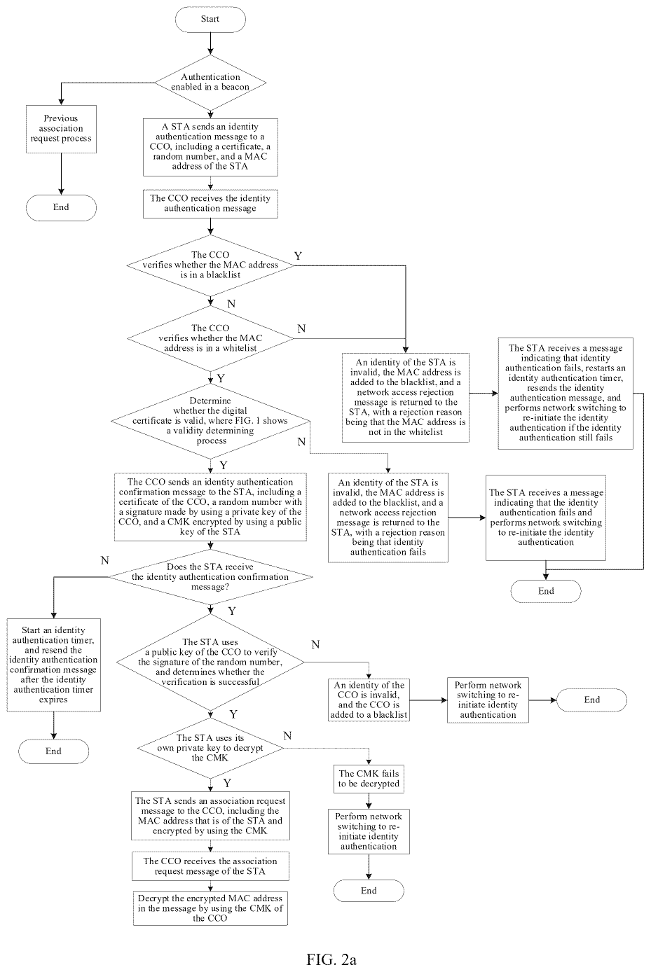

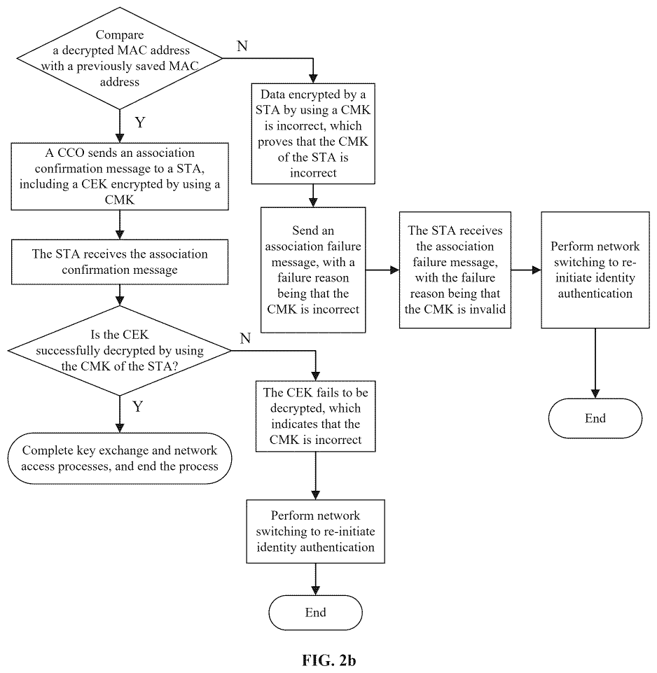

Referring to FIG. 2a and FIG. 2b, an identity authentication process for secure network access of the dual-mode node is exemplarily described. A STA that has not been connected to the power communication network receives a beacon sent by the CCO, and determines, based on this beacon, that the current security mode is the encrypted mode. Whether communication data needs to be encrypted is determined. For both the dual-mode node in the compatible mode and the dual-mode node in the forced mode, the data needs to be encrypted. Therefore, in a re-networking process of the restarted CCO, a dual-mode node Y sends a second network access request to the CCO. The second network access request carries identity authentication information, including a MAC address, an identity certificate, and a random number of the dual-mode node Y.

Still referring to FIG. 2a, the CCO receives the identity authentication information sent by the dual-mode node Y. The identity authentication information includes the MAC address, the identity certificate, and the random number of the dual-mode node Y. Firstly, the CCO determines, based on the MAC address of the dual-mode node Y, whether network access is allowed, in other words, determines whether the MAC address of the dual-mode node Y is in a blacklist or is not in the whitelist. If the MAC address of the dual-mode node Y is not in the whitelist, the dual-mode node Y is added to the blacklist, and a network access rejection message is returned to the dual-mode node Y, carrying a rejection reason that the dual-mode node Y is not in the whitelist.

Still referring to FIG. 2a, if it is determined based on the MAC address of the dual-mode node Y that the network access is allowed, it is required to further determine whether the identity certificate of the dual-mode node Y is valid. If the identity certificate of the dual-mode node Y is invalid, the dual-mode node Y is added to the blacklist, and a network access rejection message is returned to the dual-mode node Y, carrying a rejection reason that the certificate of the dual-mode node Y is invalid.

Still referring to FIG. 2a, if the dual-mode node Y receives the rejection message indicating that the dual-mode node Y is not in the whitelist, the dual-mode node Y resends the identity authentication information to the CCO. If the identity authentication still fails, the dual-mode node Y switches to another power communication network and requests to connect to the another power communication network.

Still referring to FIG. 2a, if the dual-mode node Y receives the rejection message indicating that the certificate is invalid, the dual-mode node Y switches to the another power communication network and requests to connect to the another power communication network.

Still referring to FIG. 2a, if the dual-mode node Y does not receive a response message from the CCO, the dual-mode node Y restarts a timer. After timing duration is reached, the dual-mode node Y resends the identity authentication information of the dual-mode node Y to the CCO.

Still referring to FIG. 2a, if the identity certificate of the dual-mode node Y is valid, the CCO extracts public key information from the identity certificate of the dual-mode node Y, encrypts the CMK by the extracted public key information, and encrypts the random number of the dual-mode node Y by a private key of the CCO. The CCO sends its own identity certificate, the encrypted random number, and the encrypted CMK together to the dual-mode node Y.

Still referring to FIG. 2a, the dual-mode node Y verifies whether the identity certificate of the CCO and the encrypted random number are correct. If the identity certificate of the CCO and the encrypted random number are correct, the encrypted CMK is decrypted to obtain and save the CMK. The MAC address of the dual-mode node Y is encrypted by the CMK, to obtain the MAC address encrypted by the CMK. The MAC address encrypted by the CMK is sent to the CCO in an association request. If the identity certificate of the CCO and the encrypted random number are incorrect, the dual-mode node Y adds the CCO to a blacklist of the dual-mode node Y.

Still referring to FIG. 2b, the CCO receives the association request from the dual-mode node Y and decrypts, by the CMK, the MAC address encrypted by the CMK, to obtain the MAC address of the dual-mode node Y. The decrypted MAC address of the dual-mode node Y is compared with the MAC address of the dual-mode node Y in the identity authentication information. If the decrypted MAC address of the dual-mode node Y is consistent with the MAC address of the dual-mode node Y in the identity authentication information, the CEK is encrypted by the CMK, the encrypted CEK is carried in an association confirmation message or an association summarization message and sent to the dual-mode node Y. The dual-mode node Y decrypts the encrypted CEK by the CMK, to obtain and save the CEK. If the dual-mode node Y fails to decrypt the encrypted CEK by the CMK, the dual-mode node Y switches to the another power communication network and requests to connect to the another power communication network. If the decrypted MAC address of the dual-mode node Y is inconsistent with the MAC address of the dual-mode node Y in the identity authentication information, an association failure message is sent to the dual-mode node Y. The association failure message is used to notify the dual-mode node Y that the CMK is incorrect.

Still referring to FIG. 2b, after receiving the association failure message, the dual-mode node Y switches to the another power communication network and requests to connect to the another power communication network. Otherwise, the network access process of the single-mode node is followed.

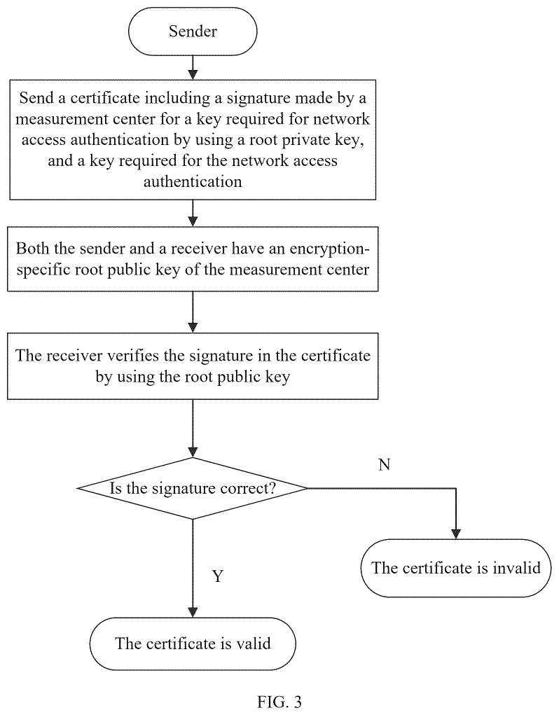

A verification process of the identity certificate is exemplarily described. The dual-mode node can use two encryption algorithms: an asymmetric encryption algorithm represented by SM2 and a symmetric encryption algorithm represented by SM4-CBC. Considering a requirement for timeliness in data transceiving, the symmetric encryption algorithm can be used to encrypt the communication data. In addition, to ensure reliable transmission of the data, the asymmetric encryption algorithm is used to perform encryption transmission on an encryption key in the symmetric encryption algorithm. In asymmetric encryption, it is required to extract public and private keys based on an identity certificate provided by a third party (such as the State Grid Measurement Center). Therefore, the certificate needs to be verified first to ensure correctness of the extracted public and private keys. FIG. 3 shows a verification process of validity of a certificate. Referring to FIG. 3, a sender sends the certificate to a receiver. The sent certificate contains a signature that is of a key required for a network access certificate and made by the measurement center by a root private key, and the key required for the network access certificate. Both the sender and the receiver have an encryption-specific root public key of the measurement center. The receiver uses the root public key to verify the signature in the certificate. If the signature is correct, the certificate of the sender is valid, and subsequent encryption and decryption can be performed. If the signature is incorrect, the certificate of the sender is invalid, and the subsequent encryption and decryption cannot be performed.

Further, the CMK is mainly used for data encryption related to the network access process, and has a characteristic of low usage efficiency. The CEK is used for data encryption throughout an entire business cycle after the network access, and has characteristics of long usage time and high efficiency. To prevent the CEK from being attacked during long-term use, the CEK can be updated regularly, and different CEKs can be used for the data encryption in different time periods. The CEK is updated regularly, and an update cycle may be set to N. A current CEK used by the CCO in a current cycle is denoted as CEK (K), and a CEK used by the CCO in a next cycle is denoted as CEK (K+1).

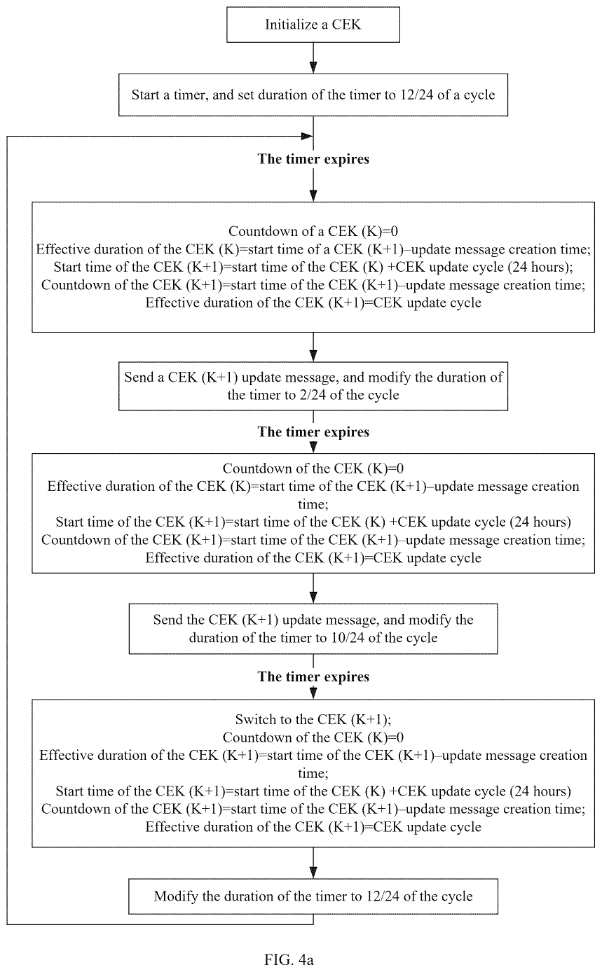

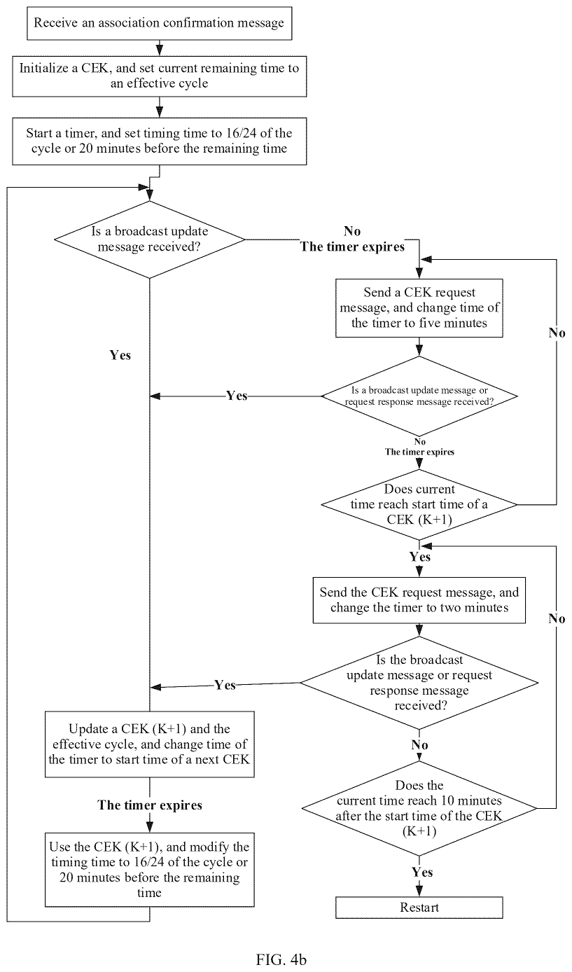

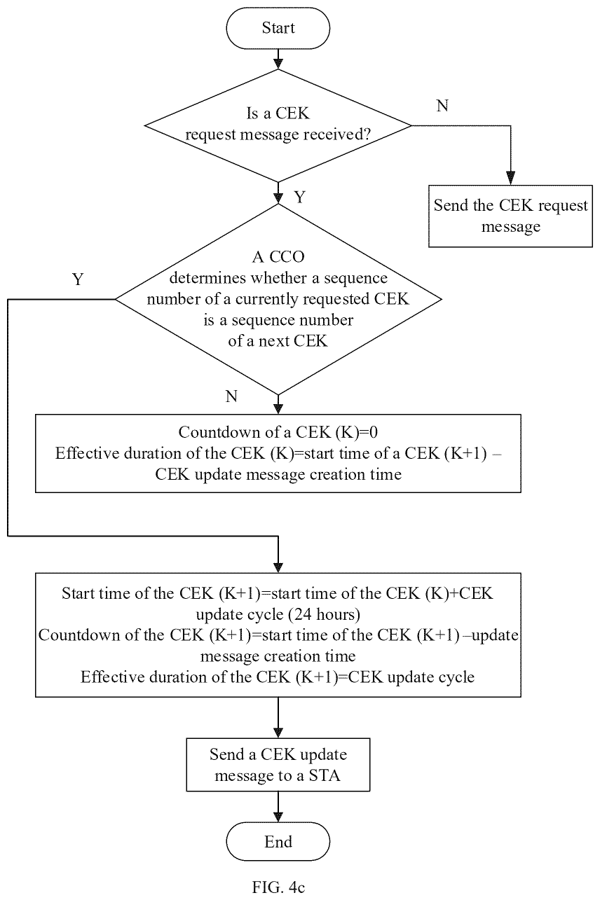

FIG. 4a shows a process of sending a CEK update message by a CCO. The CEK update message is regularly broadcast by the CCO.

When the CCO performs re-networking after being restarted, the CEK is initialized, and the CCO starts a timer. Duration of the timer is set to (12/24)*N. When the timer expires, current time is T1, and the CCO performs following settings:
countdown of the CEK (K)=0;
effective duration of the CEK (K)=start time of the CEK (K+1)-update message creation time T1;
start time of the CEK (K+1)=start time of the CEK (K)+CEK update cycle;
countdown of the CEK (K+1)=start time of the CEK (K+1)-update message creation time T1; and
effective duration of the CEK (K+1)=CEK update cycle.

It should be noted that since the CEK (K) is currently being used, the countdown of the CEK (K) is equal to 0. In a process of using the CEK (K), the effective duration of the CEK (K) is equal to the countdown of the CEK (K+1). The countdown of the CEK (K+1) can be understood as a countdown of using the CEK (K+1). Therefore, when the CEK update message is broadcast at the current time, the update message creation time can be understood as the current time.

The CCO sends a CEK (K+1) update message to the dual-mode node for the first time, and simultaneously modifies the duration of the timer to (2/24)*N. After the timer expires, the current time is T2, and the CCO performs following settings:
countdown of the CEK (K)=0;
effective duration of the CEK (K)=start time of the CEK (K+1)-update message creation time T2;
start time of the CEK (K+1)=start time of the CEK (K)+CEK update cycle;
countdown of the CEK (K+1)=start time of the CEK (K+1)-update message creation time T2; and
effective duration of the CEK (K+1)-CEK update cycle.

The CCO sends the CEK (K+1) update message to the STA for the second time. So far, the CCO broadcasts the CEK (K+1) update message twice.

After broadcasting the CEK (K+1) update message twice, the CCO modifies the duration of the timer to (10/24)*N. After the timer expires, the CEK (K) needs to be switched to the CEK (K+1), and the CEK (K+1) is used as the CEK that is currently being used. After that, the above steps are repeated, and the timer is started. The duration of the timer is set to (12/24)*N until a new key update cycle is reached.

Further, the CCO may send the CEK update messages to actively send the CEK (K+1), or the STA may request the CEK (K+1). FIG. 4b shows a process of sending a CEK request message by the STA.

In any situation such as a data loss, short network access time for the STA, or a need to switch to the CEK (K+1) just after the STA is connected to the network, the STA sends the CEK request message to the CCO. For example, if the STA has not yet obtained the CEK (K+1) of the next cycle when ⅓ of a validity period of the CEK is left or a remaining validity period of the CEK is less than 20 minutes, the STA requests the CCO for the CEK (K+1) of the next cycle. The STA sends the CEK request message to the CCO, and the CCO responds to the CEK request message of the STA.

In this example, a request is sent once when ⅓ of the validity period of the CEK is left or the remaining validity period of the CEK is less than 20 minutes. If the CEK (K+1) is still not received, the request is resent every 5 minutes until the start time of the CEK (K+1). If the CEK (K+1) is still not received, the request is sent every 2 minutes until 10 minutes after the start time. If the CEK (K+1) is still not received, the STA is restarted.

In this example, when receiving the association confirmation message, the STA initializes the CEK and sets current remaining duration of the CEK to the key update cycle. The timer is started, and the duration of the timer is set to (16/24)*N or the remaining duration is set to 20 minutes. Before the timer expires, if receiving the CEK update message broadcast by the CCO, the STA updates the CEK (K+1) and an effective cycle, and changes time of the timer to the start time of the CEK (K+1). After the timer expires, the operation of starting the timer and setting the duration of the timer to (16/24)*N or the remaining time to 20 minutes is cyclically performed.

If the STA does not receive the CEK update message broadcast by the CCO, the STA sends the CEK request message to the CCO and changes the time of the timer to 5 minutes, which means sending the CEK request message to the CCO once every 5 minutes. If the CEK update message or a CEK request confirmation message is received before the timer expires each time, the CEK (K+1) and the effective cycle are updated, and the time of the timer is changed to the start time of the CEK (K+1). Otherwise, after the timer expires, the CEK request message is sent to the CCO until the start time of the CEK (K+1) is reached. The STA sends the CEK request message to the CCO and modifies the timer to 2 minutes, which means sending the CEK request message to the CCO once every 2 minutes. If the CEK update message or the CEK request confirmation message is received before the timer expires each time, the CEK (K+1) and the effective cycle are updated, and the time of the timer is changed to the start time of the CEK (K+1). Otherwise, after the timer expires, the CEK request message is sent to the CCO until 10 minutes after the start time of the CEK (K+1) is reached. If no CEK update message or CEK request confirmation message is received, the STA is restarted, that is, the STA performs a hardware reset, is powered off and on, and then is reconnected to the network. It should be noted that network switching is not performed at this time.

Further, FIG. 4c shows a process of sending a CEK confirmation message by the CCO. After receiving the CEK request message, the CCO encrypts the CEK by the CMK and returns the encrypted CEK to the STA. The CEK request message carries a sequence number of a currently request CKE. The CCO receives the CEK request message, and determines whether the sequence number of the currently request CEK is a sequence number of a next CEK. If the sequence number of the currently request CEK is not the sequence number of the next CEK, a following update is performed:
countdown of the CEK (K)=0; and
effective duration of the CEK (K)=start time of the CEK (K+1)-update message creation time;
If the sequence number of the currently request CEK is the sequence number of the next CEK, a following update is performed:
start time of the CEK (K+1)=start time of the CEK (K)+CEK update cycle;
countdown of the CEK (K+1)=start time of the CEK (K+1)-update message creation time; and
effective duration of the CEK (K+1)=CEK update cycle.

The CCO sends the CEK update message to the STA.

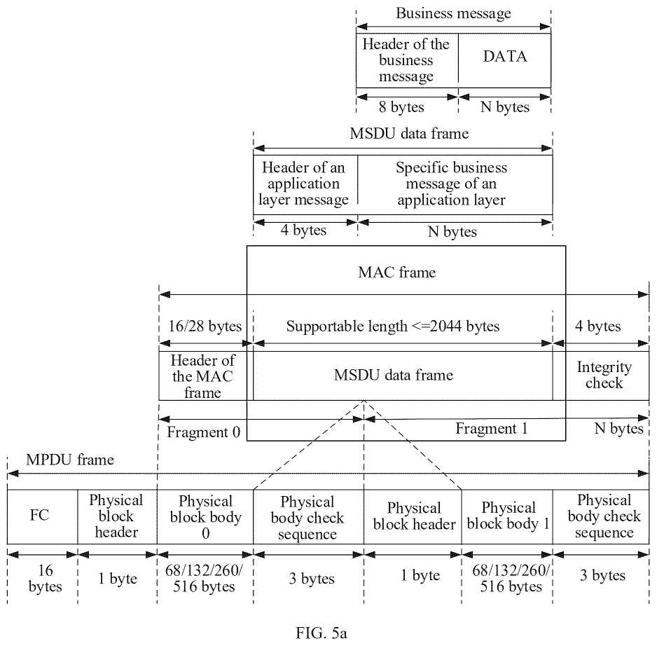

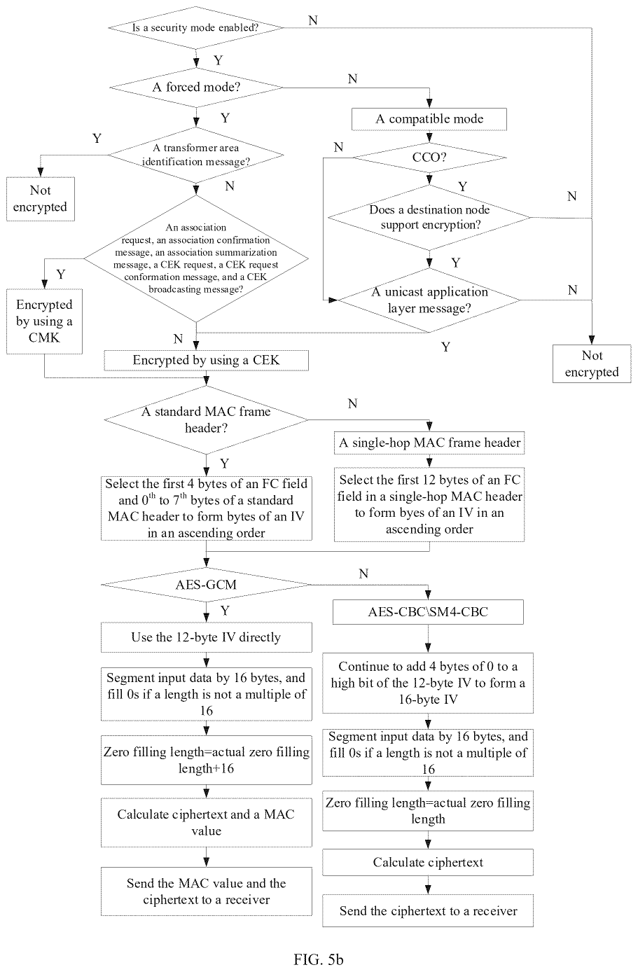

How to perform encryption and decryption in a business data transceiving process is exemplarily described. A hierarchical structure includes a business layer, an application layer, a link layer, and a physical layer. When being transmitted between different devices or STAs, business data should be encapsulated layer by layer according to a hierarchical structure requirement of a protocol stack, and finally transmitted through the physical layer and a power line/spatial radiation. When being submitted to the application layer, a data message received by the physical layer through the power line or the spatial radiation needs to be reversely decomposed and extracted layer by layer according to an encapsulation process. Finally, the business data is submitted to the application layer. FIG. 5a shows a data structure corresponding to each layer. In this example, a MAC service data unit (MSDU) data frame is encrypted.

It should be noted that if the CCO is a business data sending end and performs an encryption operation, the STA is a business data receiving end and performs a decryption operation. If the STA is the business data sending end and performs the encryption operation, the CCO is the business data receiving data and performs the decryption operation. Therefore, a data encryption and transmission process is the same for both the CCO and the STA. Therefore, in this example, a module end is used as an example for description.

In this example, FIG. 5b shows the data encryption and transmission process. When the business data is sent at the module end, the module end first determines whether it has enabled the encrypted mode. If the encrypted mode has not been enabled, the module end directly sends the business data without performing the encryption operation. If the encrypted mode has been enabled, based on a current encryption mode and whether a destination node supports the encrypted mode, the module end determines whether to encrypt the data. During data encryption, the encryption key can be selected based on the encryption mode and a type of the business data. For the association request, the association confirmation message, the association summarization message, the CEK request message, the CEK confirmation message, and the CEK update message in the forced mode, the CMK is selected. For other cases such as the application layer message, the CEK is selected. An initialization vector (IV) can be selected based on a MAC frame type. Under a standard MAC frame, the first 4 bytes of a frame control (FC) field and 0th to 7^{th} bytes of a standard MAC header are selected to form bytes of the IV in an ascending order. Under a single-hop MAC frame, the first 12 bytes of an FC field in a single-hop MAC header are selected to form the byes of the IV in the ascending order. The IV is combined with a key to form a key seed to generate an encrypted byte stream to encrypt data.

Encryption types specifically supported are classified into three categories: AES-GCM encryption, AES-CBC encryption, and SM4-CNC encryption. When the AES-GCM encryption is used, zero filling needs to be performed on input data first, and a string length of the input data needs to be supplemented to a multiple of 16. Then, the data is encrypted based on the selected key type and the IV. Finally, obtained ciphertext and a MAC value are sent to the receiver. When the AES-CBC encryption and the SM4-CNC encryption are used, the input data also needs to be supplemented to a multiple of 16 through the zero filling. Then a high bit of the IV needs to be supplemented to 16 bytes through the zero filling. After that, the data is encrypted based on the selected key type and the IV, and finally the obtained ciphertext is sent to the receiver.

In this example, FIG. 5c shows a data decryption and reception process. When the business data is received at the module end, the module end can determine, based on a MAC frame header, whether the received data is encrypted and the key type. If the received data is not encrypted, the received data is processed directly. If the received data is encrypted, the data is decrypted.

During the data decryption, the key type can be directly obtained from the MAC frame header. The IV is selected based on the MAC frame type. Under the standard MAC frame, the first 4 bytes of the FC field and the 0^{th} to 7^{th} bytes of the standard MAC header are selected to form the bytes of the IV in the ascending order. Under the single-hop MAC frame, the first 12 bytes of the FC field in the single-hop MAC header are selected to form the byes of the IV in the ascending order.

The data decryption is completed based on a corresponding encryption type: the AES-GCM encryption, the AES-CBC encryption, or the SM4-CNC encryption. When AES-GCM decryption is used, the selected key type and the IV are used to decrypt the data, where the last 16 bytes of the data are the MAC value. When the other two decryption methods are used, the high bit of the IV needs to be supplemented to 16 bytes through the zero filling. After that, the data is decrypted based on the selected key type and the IV. If the above decryption is successful, a SACK value indicating successful decryption is returned. Otherwise, a SACK value indicating failed decryption is returned.

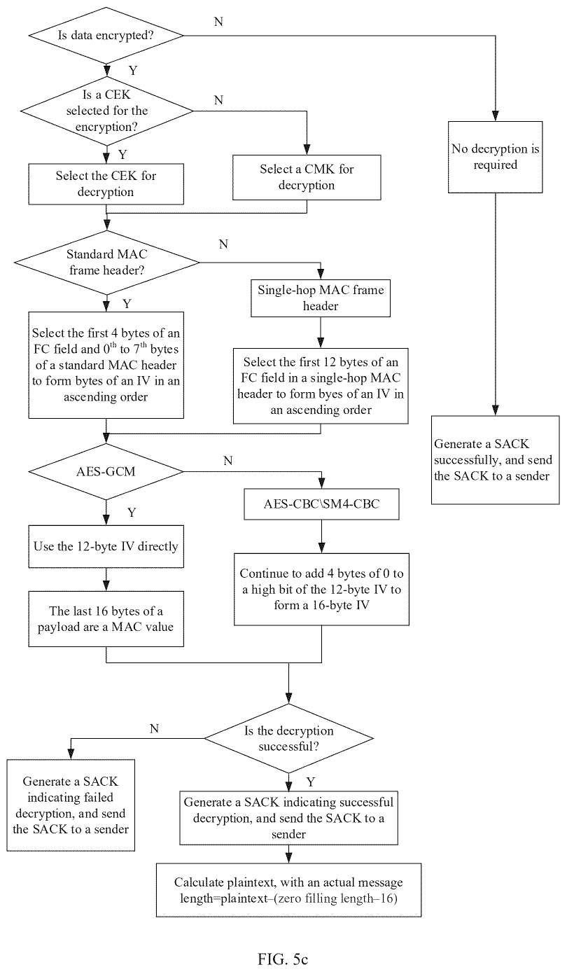

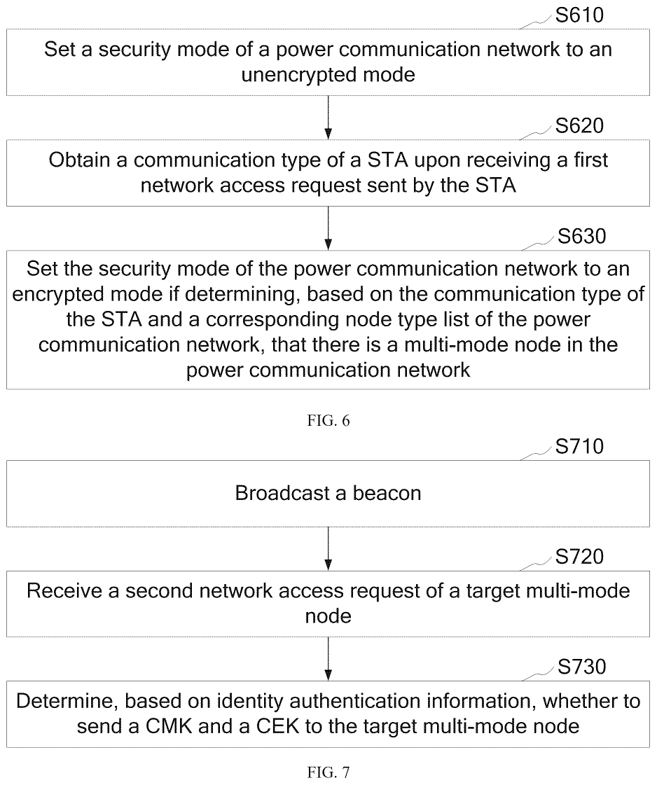

In some embodiments, a security control method for a power communication network is provided, which is applied to a CCO included in the power communication network. Referring to FIG. 6, the security control method includes following steps:

S610: Set a security mode of the power communication network to an unencrypted mode.

S620: Obtain a communication type of a STA upon receiving a first network access request sent by the STA.

S630: Set the security mode of the power communication network to an encrypted mode if determining, based on the communication type of the STA and a corresponding node type list of the power communication network, that there is a multi-mode node in the power communication network.

The node type list stores a communication type of a STA that has been connected to the power communication network. The multi-mode node may be a node based on two communication modes (such as a dual-mode node), or a node based on a plurality of communication modes. A communication mode of the multi-mode node may include at least two communication modes: HPLC and HRF communication. Alternatively, the communication mode of the multi-mode node may include at least one of an Ethernet, a mobile link, a Bluetooth link, a WIFI link, a LoRa link, a ZigBee link, and an Rs-485 link.

In some cases, an electricity consumption information collection system may contain a single-mode node not supporting a security encryption function, and may contain a multi-mode node supporting the security encryption function. Regarding the CCO, a communication type existing in the power communication network is unknown. Firstly, in order to ensure that the single-mode node not supporting the security encryption function can be successfully connected to the power communication network, the CCO initially sets the security mode of the power communication network to the unencrypted mode. In the initially set unencrypted mode, the single-mode node can be allowed to connect to the power communication network. Secondly, in order to ensure secure communication of the multi-mode node supporting the security encryption function, and to implement a security control policy based on normal communication, after the security mode of the power communication network is initially set to the unencrypted mode, a first network access request sent by each communication module needs to carry a communication type of the communication module to set a security mode suitable for an actual situation based on the communication type existing in the power communication network. For example, if there is the multi-mode node, the security mode of the power communication network should be set to the encrypted mode.

Specifically, the CCO is initially powered on and sets the security mode of the power communication network to the unencrypted mode. In the unencrypted mode, the CCO allows a STA in a whitelist to connect to the network. The STA sends the first network access request to the CCO. The first network access request carries the communication type of the STA. The CCO receives the first network access request sent by the STA, and obtains the communication type of the STA. The CCO stores the corresponding node type list of the power communication network in advance. The node type list stores the communication type of the STA that has been connected to the power communication network. The carried communication type of the STA in the first network access request and a communication type existing in the node type list are analyzed to determine whether there is the multi-mode node in the power communication network. If there is the multi-mode node in the power communication network, it indicates that a security policy needs to be provided for the multi-mode node supporting the security encryption function. Therefore, the security mode of the power communication network is set to the encrypted mode.

In the above embodiments, the CCO initially sets the security mode of the power communication network to the unencrypted mode. In the unencrypted mode, the first network access request of the STA is received, and whether to enable the encrypted mode is determined based the carried communication type of the STA in the first network access request and a communication type of each STA in the power communication network. When there is the multi-mode node in the power communication network, the security mode of the power communication network is set to the encrypted mode. This realizes compatibility between the single-mode node and the multi-mode node, achieves security control based on the normal communication, improves secure communication between the CCO and the STA, reduces a probability of an eavesdropping event, and implements a direct secure anti-eavesdropping solution between the CCO and the STA.

In some embodiments, the security control method may further include: keeping the security mode of power communication to be the unencrypted mode if determining, based on the communication type of the STA and the corresponding node type list of the power communication network, that all STAs in the power communication network are single-mode nodes.

The single-mode node is a module that performs communication based on the HPLC. The CCO stores the corresponding node type list of the power communication network in advance. The node type list stores the communication type of the STA that has been connected to the power communication network. The carried communication type of the STA in the first network access request and the communication type existing in the node type list are analyzed to determine whether there is the multi-mode node in the power communication network. If an analysis result shows that all the STAs in the power communication network are the single-mode nodes, it indicates that there is no multi-mode node supporting an encryption function and the encrypted mode cannot be enabled. Therefore, the CCO keeps the security mode of the power communication network to be the unencrypted mode.

In the above embodiments, based on a determining result that all the STAs in the power communication network are the single-mode nodes, the security mode of the power communication network is kept to be the unencrypted mode, and a security mode that can be compatible with the single-mode node is set for an actual communication type of the STA in the power communication network to ensure normal communication of the power communication network.

In some embodiments, the setting the security mode of the power communication network to an encrypted mode if determining, based on the communication type of the STA and a corresponding node type list of the power communication network, that there is a multi-mode node in the power communication includes at least one of following cases:
if determining, based on the communication type of the STA and the corresponding node type list of the power communication network, that there is both the single-mode node and the multi-mode node in the power communication network, setting the security mode of the power communication network to a compatible mode, where in the compatible mode, an application layer message transmitted by the multi-mode node needs to be encrypted, and the multi-mode node is a STA based on at least two communication modes: the HPLC and HRF communication; or
if determining, based on the communication type of the STA and the corresponding node type list of the power communication network, that all the STAs in the power communication network are multi-mode nodes, setting the security mode of the power communication network to a forced mode, where in the forced mode, other messages than a transformer area identification message need to be encrypted.

Specifically, the CCO stores the corresponding node type list of the power communication network in advance. The node type list stores the communication type of the STA that has been connected to the power communication network. The carried communication type of the STA in the first network access request and the communication type existing in the node type list are analyzed. If it is determined that there is both the single-mode node and the multi-mode node in the power communication network, the security mode of the power communication network is set to the compatible mode. In this case, the CCO needs to be restarted, and all the STAs in the power communication network need to request network access again in the compatible mode. In the compatible mode, the single-mode node can perform communication in an unencrypted form, while the application layer message transmitted by the multi-mode node needs to be encrypted, and messages in other forms may not be encrypted for communication.

If it is determined that all the STAs in the power communication network are the multi-mode nodes, it indicates that each STA in the power communication network supports the encryption function. In this case, without considering compatibility with the single-mode node, the security mode of the power communication network is set to the forced mode, and the other messages than the transformer area identification message all need to be encrypted to improve communication security performance.

In the above embodiments, the compatible mode or the forced mode is flexibly set for the actual communication type of the STA in the power communication network, to be compatible with the single-mode node and the multi-mode node. This can implement the security policy based on the normal communication.

In some embodiments, the security control method may further include at least one of following cases: after setting the security mode to the compatible mode, receiving a second network access request sent by the STA in the power communication network in the compatible mode, to perform re-networking; or after setting the security mode to the forced mode, receiving a second network access request sent by the STA in the power communication network in the forced mode, to perform re-networking.

Specifically, after setting the security mode to the compatible mode, the CCO needs to be restarted. After being restarted, the CCO receives the second network access request that is sent by the STA to the CCO in the compatible mode, to perform the re-networking.

After setting the security mode to the forced mode, the CCO needs to restart. After being restarted, the CCO receives the second network access request that is sent by the STA to the CCO in the forced mode, to perform the re-networking.

In the above embodiments, after the CCO is restarted, the STA resends the second network access request to perform the re-networking to achieve secure communication in a security mode (compatible mode or forced mode) that matches an actual communication type of the STA in the power communication network. Moreover, different security schemes can be adopted to encrypt and decrypt sent business data.

In some embodiments, after obtaining the communication type of the STA, the security control method may further include: recording the communication type of the STA in the corresponding node type list of the power communication network.

Specifically, before conducting secure communication with the STA, the CCO can store the corresponding communication type of the STA in the corresponding node type list of the power communication network.

In other cases, before conducting the secure communication with the STA, the CCO can store information such as the STA, a corresponding level of the STA, the corresponding communication type of the STA, and a network node attribute of the STA in a corresponding topology list of the power communication network in the CCO. Based on the information data that is of the STA in the power communication network and stored in the topology list, a topological graph can be formed.

In some embodiments, referring to FIG. 7, the security control method may further include following steps:

S710: Broadcast a beacon.

S720: Receive a second network access request of a target multi-mode node.

S730: Determine, based on identity authentication information, whether to send a CMK and a CEK to the target multi-mode node.

The beacon carries an authentication enabling flag. The beacon is used to instruct the target multi-mode node that has not yet been connected to the network to determine a current encryption mode based on the authentication enabling flag, and send identity authentication information corresponding to the current encryption mode to the CCO. The second network access request carries the identity authentication information.

In some cases, compared with a network access process of the single-mode node, normal network access of the multi-mode node requires secure exchange of the CMK and the CEK in symmetric encryption.

Specifically, the broadcast beacon carries the authentication enabling flag. When the authentication enabling flag in the beacon is enabled, a target multi-mode node that requests second network access is the target multi-mode node that has not yet connected to the network. The target multi-mode node that has not yet be connected to the network can obtain a current security mode based on the beacon sent by the CCO. The CCO receives the second network access request of the target multi-mode node, obtains the identity authentication information that corresponds to the current encryption mode and is sent by the target multi-mode node, and authenticates the target multi-mode node based on the identity authentication information. If the authentication is successful, the CMK can be sent to the target multi-mode node, and the CEK can also be sent to the target multi-mode node simultaneously. If the authentication fails, neither the CMK nor the CEK is sent to the target multi-mode node.

In other implementations, after the CMK is sent to the target multi-mode node, a step of performing identity authentication on the CCO by the STA can be set. If passing the identity authentication performed by the STA on the CCO, the CCO can send the CEK to the target multi-mode node. In other words, the CCO first sends the CMK to the target multi-mode node and then sends the CEK to the target multi-mode node. In addition, if the CCO fails to pass the identity authentication performed by the STA on the CCO, the CCO no longer sends the CEK to the target multi-mode node.

In the above embodiments, whether to send the CMK and the CEK to the target multi-mode node can be determined flexibly based on the identity authentication information. This can implement the security policy based on the normal communication.

In some embodiments, the identity authentication information includes a first random number, a MAC address of the target multi-mode node, and first certificate data; and the determining, based on identity authentication information, whether to send a CMK and a CEK to a target multi-mode node includes: if the MAC address of the target multi-mode node is in a network access whitelist of the CCO and the first certificate data is verified to be valid, encrypting the first random number by a private key of the CCO; extracting first public key information from the first certificate data, and encrypting the CMK based on the extracted first public key information; and sending the encrypted first random number, the encrypted CMK, and second certificate data of the CCO to the target multi-mode node, such that when the second certificate data is verified to be valid and the encrypted first random number passes signature verification, the target multi-mode node decrypts the encrypted CMK by a private key of the target multi-mode node, and saves the decrypted CMK.

The first certificate data may include a signature made for a key required for the first certificate data by a third party by a root key, and a key required for network access authentication. The MAC address can be used to uniquely confirm the STA.

Specifically, whether the MAC address of the target multi-mode node is in the network access whitelist of the CCO is determined. If the MAC address of the target multi-mode node is in the network access whitelist of the CCO, whether the first certificate data is valid is further verified. If the first certificate data is valid, the CCO can use the private key of the CCO to encrypt the first random number. The CCO can extract the first public key information from the first certificate data and use the extracted first public key information to encrypt the CMK. The CCO can send an identity authentication confirmation message containing the encrypted first random number, the encrypted CMK, and the second certificate data of the CCO to the target multi-mode node. After receiving the identity authentication confirmation message, the target multi-mode node can verify validity of the second certificate data, and use a public key of the CCO to perform the signature verification on the encrypted first random number. When the second certificate data is invalid, an identity authentication timer can be started. When the identity authentication timer expires, the identity authentication confirmation message can be sent again. When the first random number fails to pass the signature verification, it can be considered that an identity of the target multi-mode node is invalid. The MAC address of the target multi-mode node can be added to a network access blacklist of the CCO, and then network switching can be performed to initiate identity authentication again. When the second certificate data is valid and the encrypted first random number passes the signature verification, the target multi-mode node can use its own private key to decrypt the encrypted CMK. If the decryption is successful, the target multi-mode node can save the CMK. So far, the CCO and the target multi-mode node exchange the CMK. If the decryption fails, the network switching can be performed to initiate the identity authentication again.

In the above embodiments, after it is confirmed that the MAC address of the target multi-mode node is in the network access whitelist of the CCO and the first certificate data is verified to be valid, the second certificate data of the CCO is sent to the target multi-mode node, such that when the second certificate data is valid and the encrypted first random number passes the signature verification, the target multi-mode node uses its own private key to decrypt the encrypted CMK, and saves the decrypted CMK. This can improve the secure communication between the CCO and the STA.

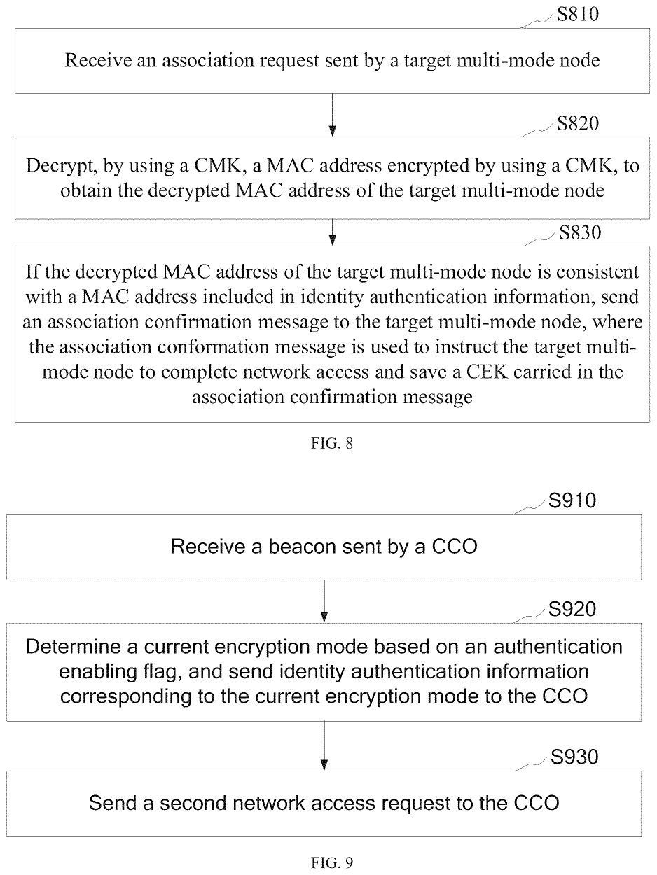

In some embodiments, referring to FIG. 8, the determining, based on identity authentication information, whether to send a CMK and a CEK to a target multi-mode node may include following steps:

S810: Receive an association request sent by the target multi-mode node.

S820: Decrypt, by the CMK, the MAC address encrypted by the CMK, to obtain the decrypted MAC address of the target multi-mode node.

S830: If the decrypted MAC address of the target multi-mode node is consistent with the MAC address included in the identity authentication information, send an association confirmation message to the target multi-mode node.

The association request carries the MAC address that is of the target multi-mode node and encrypted by the CMK. The association confirmation message is used to instruct the target multi-mode node to complete network access and save a CEK carried in the association confirmation message.

In some cases, when the second certificate data is valid and the encrypted first random number passes the signature verification, the target multi-mode node can use its own private key to decrypt the encrypted CMK, and save the decrypted CMK. In this case, in order to further improve the secure communication, the target multi-mode node needs to send the association request to the CCO. Specifically, the target multi-mode node can encrypt the MAC address of the target multi-mode node by the CMK. The target multi-mode node can send the association request carrying the MAC address that is of the target multi-mode node and encrypted by the CMK to the CCO. After receiving the association request sent by the target multi-mode node, the CCO can use the CMK to decrypt the MAC address encrypted by the CMK, to obtain the decrypted MAC address of the target multi-mode node. The decrypted MAC address of the target multi-mode node can be compared with the MAC address included in the identity authentication information. If the decrypted MAC address of the target multi-mode node is consistent with the MAC address included in the identity authentication information, the CCO can send the association confirmation message to the target multi-mode node. The target multi-mode node receives the association confirmation message. The association confirmation message can be used to instruct the target multi-mode node to complete the network access. If the network access is successful, the target multi-mode node saves the CEK carried in the association confirmation message.

In the above embodiments, after the target multi-mode node completes the identity authentication on the CCO and the CCO completes the identity authentication on the target multi-mode node, the target multi-mode node sends the association request to the CCO. After confirming that the decrypted MAC address of the target multi-mode node is consistent with the MAC address included in the identity authentication information, the CCO sends the association confirmation message to the target multi-mode node to instruct the target multi-mode to complete the network access, which can ensure network security. Furthermore, the association confirmation message carries the CEK to exchange the CEK between the CCO and the target multi-mode node.

In some embodiments, before sending the association confirmation message to the target multi-mode node, the security control method may further include: encrypting the CEK by the CMK, to obtain the encrypted CEK.

The association confirmation message carries the encrypted CEK, and the association confirmation message is used to instruct the target multi-mode node to decrypt the encrypted CEK by the CMK, to obtain and save the CEK.

Specifically, when the decrypted MAC address of the target multi-mode node is consistent with the MAC address included in the identity authentication information, the CCO can use the CMK to encrypt the CEK to obtain the encrypted CEK, and send the encrypted CEK to the target multi-mode node by carrying the encrypted CEK in the association confirmation message. After receiving the association confirmation message, the target multi-mode node can use the CMK to decrypt the encrypted CEK. If the decryption is successful, the CEK can be obtained, and the target multi-mode node can store the CEK. If the decryption fails, it indicates that the CMK is incorrect, and the target multi-mode node can perform the network switching to initiate the identity authentication again.

In the above embodiments, the CMK is used to encrypt the CEK to obtain the encrypted CEK. This improves security of the CEK exchange between the CCO and the target multi-mode node, thereby further improving communication security.

In some embodiments, the security control method may further include: if the decrypted MAC address of the target multi-mode node is inconsistent with the MAC address included in the identity authentication information, sending an association failure message to the target multi-mode node. The association failure message is used to notify the target multi-mode node that the CMK is incorrect.

Specifically, the CCO uses the CMK to decrypt the MAC address encrypted by the CMK. After the decrypted MAC address of the target multi-mode node is obtained, if the decrypted MAC address of the target multi-mode node is inconsistent with the MAC address included in the identity authentication information, it can be considered that the MAC address that is of the target multi-mode node and encrypted by the CMK is incorrect. This can prove that the CMK used to encrypt the MAC address of the target multi-mode node is incorrect. The CCO can send the association failure message to the target multi-mode node, and a failure reason contained in the association failure message is that the CMK of the target multi-mode node is incorrect. After receiving the association failure message, the target multi-mode node can perform the network switching to resend an identity authentication request.

In the above embodiments, the CMK can be determined to be incorrect by determining that the decrypted MAC address of the target multi-mode node is inconsistent with the MAC address included in the identity authentication information. Therefore, it is necessary to perform the identity authentication again to obtain an accurate CMK. The encrypted MAC address is decrypted by the accurate CMK, to facilitate subsequent encryption and decryption by the CMK, thereby preventing inconsistent CMKs during entire operation of the network.

In some embodiments, the identity authentication information includes the first random number, the MAC address of the target multi-mode node, and the first certificate data. The determining, based on identity authentication information, whether to send a CMK and a CEK to a target multi-mode node includes at least one of following cases:
if the MAC address of the target multi-mode node is not in the network access whitelist of the CCO, or if the MAC address of the target multi-mode node is in the network access blacklist of the CCO, sending a network access rejection message to the target multi-mode node; and

if the first certificate data is verified to be invalid, adding the MAC address of the target multi-mode node to the network access blacklist of the CCO, and sending the network access rejection message to the target multi-mode node.

The whitelist and the blacklist may be sent by a main STA to a concentrator and then sent to the CCO by the concentrator. The whitelist and the blacklist store a MAC address of a STA that is allowed to connect to the power communication network.

Specifically, after receiving an identity authentication message, the CCO can determine, based on the included MAC address of the target multi-mode node in the identity authentication information, whether to allow the target multi-mode node to connect to the network. If the MAC address of the target multi-mode node is in the network access blacklist of the CCO, or if the MAC address of the target multi-mode node is not in the network access whitelist of the CCO, it can be considered that the target multi-mode node is not allowed to connect to the power communication network. The MAC address that is of the target multi-mode node and is not in the network access whitelist can be added to the network access blacklist of the CCO, and the network access rejection message can be returned to the target multi-mode node. A reason for rejecting the network access may be that the MAC address of the target multi-mode node is not in the network access whitelist of the CCO. After receiving the network access rejection message and the reason for rejecting the network access, the target multi-mode node can restart the identity authentication timer and resend the identity authentication message to the CCO. If the identity authentication still fails, the network switching can be performed to resend the identity authentication request.

If it is verified that the MAC address of the target multi-mode node is in the network access whitelist of the CCO, it is required to further verify whether the first certificate data is valid. If a verification result shows that the first certificate data is invalid, it can be considered that the identity of the target multi-mode node is invalid. The MAC address of the target multi-mode node with the invalid identity can be added to the network access blacklist of the CCO, and the network access rejection message can be sent to the target multi-mode node. The reason for rejecting the network access may be that the identity authentication of the target multi-mode node fails. After receiving the network access rejection message and the reason for rejecting the network access, the target multi-mode node can perform the network switching to resend the identity authentication request.

In the above embodiments, when it is determined that the MAC address of the target multi-mode node is not in the network access whitelist of the CCO, or the MAC address of the target multi-mode node is in the network access blacklist of the CCO, or the first certificate data is verified to be invalid, the network access rejection message can be sent to the target multi-mode node. This not only can improve the communication security, but also can switch to another network in a timely manner.

In some embodiments, a process of verifying the first certificate data includes: verifying a signature in the first certificate data by a root public key provided by the third party; and if the signature in the first certificate data is correct, determining that the first certificate data is valid; or if the signature in the first certificate data is incorrect, determining that the first certificate data is invalid.

In some cases, it is required to verify the certificate data by the root key, to ensure that a correct public key is subsequently extracted. The multi-mode node supports an asymmetric encryption algorithm represented by SM2 and a symmetric encryption algorithm represented by SM4-CBC. Considering a requirement of the multi-mode node for timeliness in business data transceiving, the symmetric encryption algorithm can be used to encrypt the business data. In addition, to ensure reliable transmission of the business data, the asymmetric encryption algorithm can be used to perform encryption transmission on an encryption key in the symmetric encryption algorithm. The asymmetric encryption algorithm needs to extract public and private keys based on the first certificate data provided by the State Grid Measurement Center. Therefore, it is necessary to first verify the first certificate data to ensure correctness of the extracted public and private keys. The third party may be an authentication agency that manages an entire life cycle of an electricity consumption information key, such as the State Grid Measurement Center. The root public key may be a public key of the third party.

Specifically, after receiving the first certificate data, the CCO can use the root public key provided by the third party to verify the signature in the first certificate data. If a verification result indicates that the signature in the first certificate data is correct, it can be considered that the first certificate data sent by the STA is valid, and subsequent encryption and decryption can be continuously performed on the business data. If the verification result indicates that the signature in the first certificate data is incorrect, it can be considered that the first certificate data sent by the STA is invalid, and as a result, the subsequent encryption and decryption cannot be continuously performed on the business data.

In the above embodiments, the signature in the first certificate data is verified by the root public key provided by the third party, which can ensure key security.

In some embodiments, the CEK is updated regularly, and the CEK corresponds to an update cycle. The security control method may further include: sending a key update message to the multi-mode node in the power communication network within effective duration of a current CEK.

The key update message includes first remaining effective duration of the current CEK, start time of a next-cycle CEK, and second remaining effective duration of the next-cycle CEK. The first remaining effective duration is related to the start time of the next-cycle CEK and creation time of the key update message. The second remaining effective duration is the update cycle. The start time of the next-cycle CEK is related to start time of the current CEK and the update cycle.

In some cases, the CEK is used for data encryption throughout an entire business cycle after the network access. The CEK has characteristics of long usage time and high efficiency. To prevent the CEK from being attacked during lone-term use, the CEK can be updated regularly, and different CEKs can be used for data encryption in different time periods. Therefore, within the effective duration of the current CEK, the CCO sends the key update message to the multi-mode node (multi-mode STA) in the power communication network to ensure that the multi-mode node can switch to the next-cycle CEK in a timely manner at the start time of the next-cycle CEK. It should be noted that within the effective duration of the current CEK, the key update message is correspondingly sent to the multi-mode node at at least one specified time.

In the above embodiments, within the effective duration of the current CEK, the key update message is sent to the multi-mode node in the power communication network. This can ensure effectiveness of the current CEK and ensure that the current CEK can be used for encryption and decryption.

In some embodiments, the sending a key update message to the multi-mode node in the power communication network within effective duration of a current CEK includes: if a timing reaches first preset duration within the effective duration of the current CEK, sending the key update message to the multi-mode node in the power communication network for the first time; and if the timing reaches second preset duration, sending the key update message to the multi-mode node in the power communication network for the second time.

In some cases, when the first preset duration is reached, the key update message is sent to the multi-mode node in the power communication network for the first time. When the second preset duration is reached, the key update message is sent to the multi-mode node in the power communication network for the second time. A key reception success rate of the multi-mode node in the power communication network can be improved by broadcasting the key update message twice to the multi-mode node in the power communication network.

Specifically, each time the CCO performs the re-networking, the current CEK is initialized, and the CEK carried in the association confirmation message is set as the current CEK. The CCO starts a timer, and duration of the timer may be set to the first preset duration. Since the current CEK has already been used, a countdown of the current CEK is set to 0. Within the effective time of the current CEK, if the timing reaches the first preset duration, current time may be set to the creation time of the key update message. The first remaining effective duration of the current CEK may be set to be equal to the start time of the next-cycle CEK minus the creation time of the key update message. The start time of the next-cycle CEK may be set to be equal to the start time of the current CEK plus the corresponding update cycle of the CEK. A countdown of the next-cycle CEK may be set to be equal to the start time of the next-cycle CEK minus the creation time of the key update message. The second remaining effective duration of the next-cycle CEK may be set to be equal to the corresponding update cycle of the CEK. After the timing reaches the first preset duration, the CCO sends a key update message of the next-cycle CEK to the multi-mode node in the power communication network for the first time. It should be noted that the first remaining effective duration of the current CEK is equal to the countdown of the next-cycle CEK.

After the key update message is sent to the multi-mode node in the power communication network for the first time when the timing reaches the first preset duration, the duration of the timer is changed to the second preset duration. After the timing reaches the second preset duration, the current time may be set to the creation time of the key update message, the first remaining effective duration of the current CEK may be set to be equal to the start time of the next-cycle CEK minus the creation time of the key update message, and the countdown of the next-cycle CEK may be set to be equal to the start time of the current CEK minus the creation time of the key update message. After the timing reaches the second preset duration, the CCO sends the key update message of the next-cycle CEK to the multi-mode node in the power communication network for the second time. It should be noted that creation time of the key update message sent for the first time is current time at which the key update message is sent for the first time, and creation time of the key update message sent for the second time is current time at which the key update message is sent for the second time.

In the above embodiments, when the first preset duration and the second preset duration are reached, the CCO can broadcast the key update message twice. By actively broadcasting the key update message, the CCO can avoid a decryption failure caused by a key update, thereby ensuring reliability, effectiveness, and smoothness of updating the CEK.

In some embodiments, the security control method may further include: if the timing reaches third preset duration, enabling the next-cycle CEK as the current CEK. A sum of the first preset duration, the second preset duration, and the third preset duration is equal to the update cycle.

Specifically, after the key update message is sent to the multi-mode node in the power communication network for the second time when the timing reaches the second preset duration, remaining duration of subtracting the first preset duration and the second preset duration from the update cycle may be used as the third preset duration. The duration of the timer may be set to the third preset duration. When the duration reaches the third preset duration, it indicates that the current CEK in the current cycle needs to be updated, and the next-cycle CEK is enabled as the current CEK.

For example, the update cycle may be set to N, the first preset duration may be

$$\frac{12}{24} * N ,$$

and the second preset duration may be

$$\frac{2}{24} * N .$$

Therefore, the third preset duration may be

$$N - \frac{12}{24} * N - \frac{2}{24} * N = \frac{10}{24} N .$$

In the above embodiments, when the timing reaches the third preset duration, the next-cycle CEK is enabled as the current CEK. This can prevent a single CEK from being used for a long time in a working process, reduce a possibility that the CEK is attacked, and improve the network security.

In some embodiments, the CEK is updated regularly, and the CEK corresponds to the update cycle. The security control method may further include: receiving a key request message sent by the multi-mode node in the power communication network when the multi-mode node in the power communication network does not receive the key update message; and sending the key update message to the multi-mode node in the power communication network based on the key request message.

Specifically, when receiving an association confirmation, the multi-mode node in the power communication network starts a timer and sets remaining time of the timer. After the timer expires, if the multi-mode node in the power communication network does not receive the key update message, the multi-mode node in the power communication network sends the key request message to the CCO. The CCO receives the key request message sent by the multi-mode node in the power communication network, and sends the key update message to the multi-mode node in the power communication network based on the key request message.

In the above embodiments, when the multi-mode node in the power communication network does not receive the key update message, the multi-mode node in the power communication network has a mechanism that can regularly broadcast a request in a unicast manner, which can avoid the decryption failure caused by the key update, thereby improving the reliability, the effectiveness, and the smoothness of updating the CEK.

In some embodiments, the key request message carries a sequence number of a current request. The sending the key update message to the multi-mode node in the power communication network based on the key request message includes: if the sequence number of the current request is consistent with a sequence number of the next-cycle CEK, sending a first key update message to the multi-mode node in the power communication network.

The first key update message includes the start time, the second remaining effective duration, and the countdown of the next-cycle CEK. The countdown is related to the start time of the next-cycle CEK and the creation time of the key update message. The second remaining effective duration is the update cycle. The start time of the next-cycle CEK is related to the start time of the current CEK and the update cycle.

In any situation such as a data loss, short network access time, or switching to a next cycle immediately after the network access, the multi-mode node in the power communication network may not receive the key update message. When the multi-mode node in the power communication network is within a validity period of the current CEK, the multi-mode node can request the next-cycle CEK. At this time, the sequence number of the current request is consistent with the sequence number of the next-cycle CEK.

Specifically, the CCO receives the key request message that carries the sequence number of the current request and is sent by the STA in the power communication network. If the sequence number of the current request is consistent with the sequence number of the next-cycle CEK, the CCO can set the current time to the creation time of the key update message. The CCO can update the start time of the next-cycle CEK to be equal to the start time of the current CEK plus the CEK update cycle, update the countdown to be equal to the start time of the next-cycle CEK minus the creation time of the key update message, and update the second remaining effective duration to be equal to the CEK update cycle. Then, the CCO sends the first key update message including the start time, the second remaining effective duration, and the countdown of the next-cycle CEK to the STA in the power communication network.

In the above embodiments, if the sequence number of the current request is consistent with the sequence number of the next-cycle CEK, the first key update message can be sent to the multi-mode node in the power communication network. This can avoid the decryption failure caused by the key update.

In some embodiments, the key request message carries the sequence number of the current request; and the sending the key update message to the multi-mode node in the power communication network based on the key request message may include: if the sequence number of the current request is inconsistent with the sequence number of the next-cycle CEK, sending a second key update message.

The second key update message includes the first remaining effective duration of the current CEK; and the first remaining effective duration is related to the start time of the next-cycle CEK and the creation time of the key update message.

In some cases, when effective duration of a current CEK A is zero, a next-cycle CEK B may be set to a current CEK, and a next-cycle CEK of the current CEK B is set to a next-cycle CEK C. Network access time of the multi-mode node in the power communication network is short. Therefore, the multi-mode node in the power communication network has not received a key update message corresponding to the CEK B broadcast twice by the CCO. When the multi-mode node in the power communication network is within a validity period of the current CEK B, the multi-mode node in the power communication network requests a key update message of the current CEK B. At this time, however, for the current CEK B, a key update message corresponding to the next-cycle CEK C is delivered. Therefore, at this time, the sequence number of the current request is consistent with the sequence number of the next-cycle CEK. Therefore, within a period of time after start time at which the CEK B serves as the current CEK B, both the CEK B and the CEK A can be used as inter-communication keys for data encryption and decryption. This can resolve a problem of asynchronous current keys between the CCO and the STA in the power communication network.

Specifically, the CCO receives the key request message that carries the sequence number of the current request and sent by the STA in the power communication network. If the sequence number of the current request is inconsistent with the sequence number of the next-cycle CEK, the CCO can set the current time to the creation time of the key update message. The CCO can update the first remaining effective duration to be equal to the start time of the next-cycle CKE minus the creation time of the key update message. Then, the CCO sends the second key update message including the first remaining effective duration of the current CEK to the STA in the power communication network.

In the above embodiments, if the sequence number of the current request is inconsistent with the sequence number of the next-cycle CEK, it can indicate that CEK updates of the CCO and the multi-mode node in the power communication network are not synchronized. When the sequence number of the current request is inconsistent with the sequence number of the next-cycle CEK, a CEK corresponding to the sequence number of the current request can be sent to ensure that the CEK updates of the CCO and the multi-mode node in the power communication network are synchronized.

In some embodiments, the security control method may further include: if there is to-be-sent business data in the encrypted mode, determining a data type of the to-be-sent business data and a security mode of a destination node; and selecting a corresponding key type from the CMK or the CEK based on the data type of the to-be-sent business data and the security mode of the destination node.

Specifically, when there is the to-be-sent business data in the encrypted mode, the data type of the to-be-sent business data and the security mode of the destination node can be determined. When the security mode of the destination node is not enabled, the to-be-sent business data does not need to be encrypted, and can be directly sent to the destination node. When the security mode of the destination node is enabled, the corresponding key type can be selected from the CMK or the CEK based on the data type of the to-be-sent business data and the security mode of the destination node.

In the above embodiments, whether the to-be-sent business data needs to be encrypted can be determined by determining the data type of the to-be-sent business data and the security mode of the destination node. This can reduce consumption of computer resources.

In some embodiments, if the security mode of the destination node is the forced mode, the selecting a corresponding key type from the CMK or the CEK based on the data type of the to-be-sent business data and the security mode of the destination node may further include at least one of following cases: if the data type of the to-be-sent business data belongs to a first type set, selecting the CMK to encrypt the to-be-sent business data; and

if the data type of the to-be-sent business data belongs to a second type set, selecting the CEK to encrypt the to-be-sent business data.

The first type set includes at least one of the association request, the association confirmation message, an association summarization message, the key update message, the key request message, and a key request confirmation message. The second type set includes the application layer message.

Specifically, when the security mode of the destination node is the forced mode, whether the to-be-sent business data needs to be transmitted between different CCOs can be determined. If the to-be-sent business data is transmitted between the different CCOs, there is no need to encrypt the to-be-sent business data. If the to-be-sent business data is not transmitted between the different CCOs, the data type of the to-be-sent business data can be determined. When the data type of the to-be-sent business data belongs to the first type set, the CMK is selected to encrypt the to-be-sent business data. When the data type of the to-be-sent business data belongs to the second type set, the CEK is selected to encrypt the to-be-sent business data.

In the above embodiments, the data type of the to-be-sent business data is determined, and the CMK or the CEK is selected to encrypt the to-be-sent business data. This improves the secure communication between the CCO and the STA, reduces the probability of the eavesdropping event, and implements the direct secure anti-eavesdropping solution between the CCO and the STA.

In some embodiments, if the security mode of the destination node is the compatible mode, the selecting a corresponding key type from the CMK or the CEK based on the data type of the to-be-sent business data and the security mode of the destination node may further include at least one of following cases:
if the destination node is the multi-mode node and the data type of the to-be-sent business data belongs to the application layer message, selecting CEK to encrypt the to-be-sent business data;
if the destination node is the multi-mode node and the data type of the to-be-sent business data does not belong to the application layer message, skipping encrypting the to-be-sent business data; and
if the destination node is the single-mode node, skipping encrypting the to-be-sent business data.

Specifically, when the security mode of the destination node is the compatible mode, a mode of the destination node can be determined. When the destination node is the single-mode node, the to-be-sent business data does not need to be encrypted. When the destination node is the multi-mode node, the data type of the to-be-sent business data can be determined. When the data type of the to-be-sent business data belongs to the application layer message, the CEK is selected to encrypt the to-be-sent business data. When the data type of the to-be-sent business data does not belong to the application layer message, the to-be-sent business data does not need to be encrypted.

In the above embodiments, whether the to-be-sent business data needs to be encrypted can be determined by determining that the destination node is the multi-mode node or the single-mode node and then determining the data type of the to-be-sent business data. This improves the secure communication between the CCO and the STA, reduces the probability of the eavesdropping event, and implements the direct secure anti-eavesdropping solution between the CCO and the STA.

In some embodiments, the to-be-sent business data includes an MSDU data frame; and the security control method may further include: determining an IV based on a MAC frame type; and encrypting the MSDU data frame based on the IV and the selected key type to obtain corresponding ciphertext, and sending the ciphertext.

A MAC frame is formed by FC, Duration/ID, Address, Sequence Control (SC), Data, and Cyclic Redundancy Check (CRC) fields. The FC field is a 2-byte field that defines a frame type and some control information. The Duration/ID field is a 4-byte field that contains a value (in units of us) indicating a time period during which a medium is occupied. Address 1, Address 2, Address 3, and Address 4 fields are 6-byte fields that each contain a standard IEEE 802 MAC address (48 bits for each address), and a meaning of each address depends on a distributed system (DS) bit in the FC field. The SC field is a 16-bit field consisting of 2 subfields: Sequence number (12 bits) and Fragment number (4 bits). Because a confirmation mechanism frame may be copied, a sequence number is used to filter out a duplicate frame. The Data field is a variable-length field that contains information specific to each frame transparently transmitted from a sender to a receiver. The CRC field is a 4-byte field that contains a 32-bit CRC error detection sequence to ensure that the frame is error free. In the Wired Equivalent Privacy (WEP) protocol, the IV is combined with a key to form a key seed, which serves as an input to an RC4 algorithm to generate an encrypted byte stream to encrypt data.

Subfields present in the FC field include: a Protocol Version subfield, which is a 2-bit field representing a current protocol version and is temporarily fixed to 0; a Type subfield, which is a 2-bit field that determines a function of the frame, such as management (00), control (01), or data (10), with a value of 11 reserved; a Subtype subfield, which is a 4-bit field indicating a subtype of the frame, where for example, 0000 represents the association request, and 1000 represents the beacon; a To DS subfield, which is a 1-bit field that is set to indicate that a target frame is used for a DS; a From DS is a 1-bit field that is set to indicate that the frame is from the DS; a More frag field, which is a 1-bit field that, where when this field is set to 1, it indicates that there is another fragment after the frame; a Retry subfield, which is a 1-bit field and is set to 1 if a current frame is a retransmitted earlier frame; a Power Mgmt subfield, which is a 1-bit field indicating a mode of the STA after the frame is successfully sent, where when this field is set to 1, it indicates that the STA has entered a power-saving mode; or when this field is set to 0, it indicates that the STA remains an active state; a More data subfield, which is a 1-bit field used to indicate to the receiver that the sender has more data to send than the current frame, where this field can be used by an access point to indicate to the STA in the power-saving mode that more packets are buffered, or can be used by the STA to indicate to the access point after being polled that more polling is needed because the STA has more packet data ready for transmission; and a WEP subfield, which is a 1-bit field indicating that a standard security mechanism of 802.11 is applied. A Sequence field is a 1-bit field. If this bit is set to 1, the received frame must be processed strictly in order.

Specifically, the IV can be determined based on the MAC frame type, and a method for encrypting the MSDU data frame can be selected. Different encryption methods may require IVs containing different bits, and the IV is updated based on the selected encryption method. When the MSDU data frame is encrypted by the selected encryption method, the MSDU data frame is encrypted by the selected key type and an IV of a bit quantity corresponding to the selected encryption method, to obtain the corresponding ciphertext, and the ciphertext is sent to the destination node.

For example, the IV can be determined based on the MAC frame type. Under a standard MAC frame, the first 4 bytes of the FC field and 0^{th} to 7^{th} bytes of the standard MAC frame may be selected to form bytes of the IV in an ascending order. Under a single-hop MAC frame, the first 12 bytes of an FC field in the single-hop MAC frame are selected to form the byes of the IV in the ascending order. Then the encryption method can be determined. When the encryption method is AES-GCM, the AES-GCM is used to encrypt the MSDU data frame. When the MSDU data frame is encrypted by the AES-GCM, the MSDU data frame is encrypted based on the selected key type and the IV to obtain the corresponding ciphertext, and the ciphertext is sent to the receiver. When the encryption method is AES-CBC or SM4-CNC, the AES-CBC or the SM4-CNC is used to encrypt the MSDU data frame. When the MSDU data frame is encrypted by the AES-CBC or the SM4-CNC, a high bit of the IV needs to be supplemented to 16 bytes through zero filling. Then, received business data is encrypted based on the selected key type and the 16-byte IV to obtain the corresponding ciphertext, and the ciphertext is sent to the receiver.

In the above embodiments, the IV is determined based on the MAC frame type; and the MSDU data frame is encrypted based on the IV and the selected key type to obtain corresponding ciphertext, and the ciphertext is sent. In an MSDU data transmission process, a data encryption process is designed to ensure transmission reliability of the to-be-sent business data.

In some embodiments, the security control method may further include at least one of following cases:
if the received business data is encrypted, determining the key type as the CMK or the CEK; and if the key type is the CMK, decrypting the received business data by the CMK and the IV, to obtain corresponding plaintext; and
if the key type is the CEK, decrypting the received business data by the CEK and the IV, to obtain corresponding plaintext.

Specifically, based on a MAC frame header stored in the business data, the business data receiver can determine whether the received business data is encrypted. If information data stored in the MAC frame header indicates that the received business data is encrypted, a key type corresponding to the received business data can be directly determined based on the key type stored in the MAC frame header. When the key type is the CMK, the IV can be determined based on the MAC frame type, and a corresponding decryption method can be determined based on the method for encrypting the MSDU data frame. Different decryption methods may require IVs containing different bits, and the IV is updated based on the selected decryption method. When the decryption method is used for decryption, the CMK and an IV of a corresponding bit quantity are used for data decryption. If the decryption is successful, the corresponding plaintext is obtained. When the key type is the CEK, the IV can be determined based on the MAC frame type, and a corresponding decryption method can be determined based on the method for encrypting the MSDU data frame. Different decryption methods may require IVs containing different bits, and the IV is updated based on the selected decryption method. When the decryption method is used for decryption, the CEK and an IV of a corresponding bit quantity are used for data decryption. If the decryption is successful, the corresponding plaintext is obtained.

For example, based on the MAC frame header stored in the business data, the business data receiver can determine whether the received business data is encrypted. If the information data stored in the MAC frame header indicates that the received business data is encrypted, it can be determined that the received business data is encrypted. Then, the key type corresponding to the received business data can be directly determined based on the key type stored in the MAC frame header. The IV can be determined based on the MAC frame type. Under the standard MAC frame, the first 4 bytes of the FC field and the 0^{th} to 7^{th} bytes of the standard MAC frame may be selected to form the bytes of the IV in the ascending order. Under the single-hop MAC frame, the first 12 bytes of the FC field in the single-hop MAC frame are selected to form the byes of the IV in the ascending order. Then, the encryption method can be determined. When the encryption method is the AES-GCM, the AES-GCM is used to decrypt the received business data. When the AES-GCM is used to decrypt the received business data, the received business data is decrypted by the corresponding key type of the received business data and the IV. If the decryption is successful, the corresponding plaintext can be obtained. When the encryption method is the AES-CBC or the SM4-CNC, the AES-CBC or the SM4-CNC is used to decrypt the received business data. When the received business data is decrypted by the AES-CBC or the SM4-CNC, the high bit of the IV needs to be supplemented to the 16 bytes through the zero filling. Then, the received business data is decrypted based on the key type corresponding to the received business data and the 16-byte IV. If the decryption is successful, the corresponding ciphertext can be obtained. The last 16 bytes of the plaintext are a MAC value. When the decryption is successful, a SACK value indicating successful decryption can be generated and sent to the business data sender as a response message.

In the above embodiments, if the received business data is encrypted, whether the key type is the CMK or the CEK is determined. If the key type is the CMK, the data is decrypted by the CMK and the IV, to obtain the corresponding plaintext. If the key type is the CEK, the data is decrypted by the CEK and the IV, to obtain the corresponding plaintext. Different decryption methods can be determined based on different key types, MAC frame types, and encryption methods, which can improve security of the business data.

In some embodiments, the security control method may further include: if the decryption fails, sending a decryption failure response message.

Specifically, when the data is decrypted by the CMK and the IV or by the CEK and the IV, if the decryption fails, a decryption failure can be generated and sent to the business data sender as a response message.

In some embodiments, the CCO may serve as the business data sender, and the STA may serve as the business data receiver. The STA decrypts the received business data based on the key type of the received business data. If the decryption fails, the STA can generate a SACK value indicating the decryption failure and send the SACK value to the CCO as the response message.

In other implementations, the STA may serve as the business data sender, and the CCO may serve as the business data receiver. The CCO decrypts the received business data based on the key type of the received business data. If the decryption fails, the CCO can generate a SACK value indicating the decryption failure and send the SACK value to the STA as the response message.

In the above embodiments, when the decryption fails, the decryption failure response message can be sent to notify the data sender of the decryption failure. This ensures that the data sender and receiver can make quick and reasonable processing.

In some embodiments, the present disclosure provides a security control method for a power communication network, which is applied to a STA included in the power communication network. The security control method may include: sending a first network access request to a CCO included in the power communication network when a security mode of the power communication network is an unencrypted mode.

The first network access request carries a communication type of the STA. The first network access request is used to instruct the CCO to set the security mode of the power communication network. If it is determined based on the communication type of the STA and a corresponding node type list of the power communication network that there is a multi-mode node in the power communication network, the CCO sets the security mode to an encrypted mode. The node type list stores a communication type of a STA that has been connected to the power communication network.

Specifically, in the unencrypted mode, the CCO allows a STA in a whitelist to connect to the network. The STA sends the first network access request to the CCO. The first network access request carries the communication type of the STA. The CCO receives the first network access request sent by the STA, and obtains the communication type of the STA. The CCO analyzes the carried communication type of the STA in the first network access request and a communication type existing in the node type list to determine whether there is the multi-mode node in the power communication network. If there is the multi-mode node in the power communication network, it indicates that a security policy needs to be provided for the multi-mode node supporting a security encryption function. Therefore, the security mode of the power communication network is set to the encrypted mode.

In the above embodiments, the STA included in the power communication network sends the first network access request to the CCO included in the power communication network when the security mode of the power communication network is the unencrypted mode. Based on the carried communication type of the STA in the first network access request, whether to enable the encrypted mode is further determined based on a communication type of each STA in the power communication network. This achieves security control based on normal communication, improves secure communication between the CCO and the STA, reduces a probability of an eavesdropping event, and implements a direct secure anti-eavesdropping solution between the CCO and the STA.

In some embodiments, the security control method for a power communication network may further include at least one of following cases:
when the security mode is a compatible mode, sending a second network access request to the CCO in the compatible mode to perform re-networking; and
when the security mode is a forced mode, sending the second network access request to the CCO in the forced mode to perform the re-networking.

In the compatible mode, an application layer message transmitted by the multi-mode node needs to be encrypted. The multi-mode node is a STA based on at least two communication methods: HPLC and HRF communication. In the forced mode, other messages than a transformer area identification message need to be encrypted.

Specifically, when the security mode is the compatible mode, the CCO needs to be restarted. After being restarted, the CCO receives the second network access request sent by the STA in the power communication network to the CCO in the compatible mode to perform the re-networking.

When the security mode is the forced mode, the CCO needs to be restarted. After being restarted, the CCO receives the second network access request sent by the STA in the power communication network to the CCO in the forced mode to perform the re-networking.

In the above embodiments, after the CCO is restarted, the STA resends the second network access request to perform the re-networking to achieve secure communication in a security mode (compatible mode or forced mode) that matches an actual communication type of the STA in the power communication network. Moreover, different security schemes can be adopted to encrypt and decrypt sent business data.

In some embodiments, referring to FIG. 9, for a target multi-mode node that has not been connected to the network, the security control method may further include following steps:

S910: Receive a beacon sent by the CCO.

S920: Determine a current encryption mode based on an authentication enabling flag, and send identity authentication information corresponding to the current encryption mode to the CCO.

S930: Send the second network access request to the CCO.

The beacon carries the authentication enabling flag. The second network access request carries the identity authentication information, and the identity authentication information is used to indicate whether the CCO sends a CMK and a CEK.

Specifically, the target multi-mode node can receive the beacon sent by the CCO. Then the target multi-mode node determines the current encryption mode of the target multi-mode node based on the authentication enabling flag carried in the beacon. If no data encryption is required, a network access process of a single-mode node can be followed for network access. If data encryption is required, the target multi-mode node sends the identity authentication information corresponding to the current encryption mode to the CCO, and sends the second network access request to the CCO.

In the above embodiments, different security policies can be determined by sending the identity authentication information corresponding to the current encryption mode and the second network access request to the CCO.

In some embodiments, the identity authentication information includes a first random number, a MAC address of the target multi-mode node, and first certificate data; and the security control method may further include: if the MAC address of the target multi-mode node is in a network access whitelist of the CCO and the first certificate data is verified to be valid, receiving the encrypted first random number, the encrypted CMK, and second certificate data of the CCO.

The encrypted first random number is obtained by encrypting the first random number by a private key of the CCO, and the encrypted CMK is obtained by encrypting the CMK by first public key information extracted from the first certificate data. When the second certificate data is valid and the encrypted first random number passes signature verification, the encrypted CMK is decrypted by a private key of the target multi-mode node and saved.

Specifically, when the MAC address of the target multi-mode node is in the network access whitelist of the CCO and the first certificate data is verified to be valid, the target multi-mode node can receive the first random number, the encrypted CMK, and the second certificate data of the CCO that are sent by the CCO. Then the target multi-mode node can verify validity of the second certificate data, and use a public key of the CCO to perform the signature verification on the encrypted first random number. When the second certificate data is valid and the encrypted first random number passes the signature verification, the target multi-mode node can use its own private key to decrypt the encrypted CMK. The target multi-mode node can save the CMK if the decryption is successful or perform network switching to re-initiate identity authentication if the decryption fails.

In the above embodiments, if the MAC address of the target multi-mode node is in the network access whitelist of the CCO and the first certificate data is verified to be valid, the encrypted first random number, the encrypted CMK, and the second certificate data of the CCO are received. After it is confirmed that the MAC address of the target multi-mode node is in the network access whitelist of the CCO and the first certificate data is verified to be valid, the second certificate data of the CCO is resent to the target multi-mode node, such that the target multi-mode node can improve the secure communication between the CCO and the STA when the second certificate data is valid and the encrypted first random number passes the signature verification.

In some embodiments, the security control method may further include: sending an association request to the CCO, where
the association request carries the MAC address that is of the target multi-mode node and encrypted by the CMK; if the decrypted MAC address of the target multi-mode node is consistent with the MAC address included in the identity authentication information, receiving an association confirmation message sent by the CCO; and saving the CEK carried in the association confirmation message.

Specifically, the target multi-mode node can encrypt the MAC address of the target multi-mode node by the CMK. The target multi-mode node can send the association request carrying the MAC address that is of the target multi-mode node and encrypted by the CMK to the CCO. After receiving the association request sent by the target multi-mode node, the CCO decrypts the association request to obtain the decrypted MAC address of the target multi-mode node. If the decrypted MAC address of the target multi-mode node is consistent with the MAC address included in the identity authentication information, the CCO can send the association confirmation message to the target multi-mode node. The target multi-mode node receives the association confirmation message. The association confirmation message can be used to instruct the target multi-mode node to complete the network access. If the network access is successful, the target multi-mode node saves the CEK carried in the association confirmation message.

In the above embodiments, the association request is sent to the CCO. The MAC address that is of the target multi-mode node, encrypted by the CMK, and carried in the association request is compared with the MAC address included in the identity authentication information. If they are consistent, the association confirmation message instructing the target multi-mode node to complete the network access can be sent to the target multi-mode node, and the CEK carried in the association confirmation message is saved. This can ensure network security.

In some embodiments, the security control method may further include: if a response message for the second network access request is not received from the CCO, starting a timer; and if the timer reaches preset time, resending the second network access request.

The preset time may be set based on an actual condition.

Specifically, after the target multi-mode node sends the second network access request to the CCO, if the target multi-mode node does not receive the response message for the second network access request from the CCO, the target multi-mode node can start the timer. When the timer reaches the preset time, the target multi-mode node can resend the second network access request to the CCO.

In the above embodiments, when the response message for the second network access request is not received from the CCO, the timer is started. If the timer reaches the preset time, the second network access request is resent. This ensures timely network access of the target multi-mode node.

In some embodiments, the security control method may further include at least one of following cases:
if the response message for the second network access request is received from the CCO, determining a type of the response message;
if the type of the response message is that the MAC address of the target multi-mode node is not in the network access whitelist of the CCO, re-attempting to send the second network access request; and if the network access is still unsuccessful, switching to another power communication network; and
if the type of the response message is that the first certificate data is invalid, switching to the another power communication network.

Specifically, when the target multi-mode node does not receive the response message for the second network access request from the CCO, the type of the response message can be determined. If the type of the response message is that the MAC address of the target multi-mode node is not in the network access whitelist of the CCO, the target multi-mode node can start the timer. When the timer reaches the preset time, the target multi-mode node can re-attempt to send the second network access request to the CCO. If the network access is still unsuccessful, the target multi-mode node can switch to the another power communication network to re-initiate the identity authentication. If the type of the response message is that the first certificate data is invalid, the target multi-mode node can switch to the another power communication network to re-initiate the identity authentication.

In the above embodiments, if the response message for the second network access request is received from the CCO, if the type of the response message is that the MAC address of the target multi-mode node is not in the network access whitelist of the CCO, a re-attempt is made to send the second network access request. If the network access is still unsuccessful, switching to the another power communication network is performed. If the type of the response message is that the first certificate data is invalid, the switching to the another power communication network is performed. The second network access request is resent after the switching to the another power communication network, which ensures accuracy of network selection.

In some embodiments, the security control method may further include: if the decrypted MAC address of the target multi-mode node is inconsistent with the MAC address included in the identity authentication information, receiving an association failure message, where the association failure message is used to notify the target multi-mode node that the CMK is incorrect.

Specifically, if the decrypted MAC address of the target multi-mode node is inconsistent with the MAC address included in the identity authentication information, it can be considered that the MAC address that is of the target multi-mode node and encrypted by the CMK is incorrect. This can prove that the CMK used to encrypt the MAC address of the target multi-mode node is incorrect. The target multi-mode node receives the association failure message sent by the CCO, and a failure reason contained in the association failure message is that the CMK of the target multi-mode node is incorrect.

In the above embodiments, if the decrypted MAC address of the target multi-mode node is inconsistent with the MAC address included in the identity authentication information, the association failure message is received. The association failure message is used to notify the target multi-mode node that the CMK is incorrect. This prevents inconsistent CMKs during entire operation of the network.

In some embodiments, a process of verifying the second certificate data includes: verifying a signature in the second certificate data by a root public key provided by a third party; and if the signature in the second certificate data is correct, determining that the second certificate data is valid; or if the signature in the first certificate data is incorrect, determining that the second certificate data is invalid.

Specifically, after receiving the second certificate data, the STA in the power communication network can use the root public key provided by the third party to verify the signature in the second certificate data. If a verification result indicates that the signature in the second certificate data is correct, it can be considered that the second certificate data sent by the CCO is valid, and subsequent encryption and decryption can be continuously performed on the business data. If the verification result indicates that the signature in the second certificate data is incorrect, it can be considered that the second certificate data sent by the CCO is invalid, and as a result, the subsequent encryption and decryption cannot be continuously performed on the business data.

In the above embodiments, the signature in the second certificate data is verified by the root public key provided by the third party, which can ensure key security.

In some embodiments, the CEK is updated regularly, and the CEK corresponds to an update cycle; and the security control method may further include: receiving, within effective duration of a current CEK, a key update message sent by the CCO.

The key update message includes first remaining effective duration of the current CEK, start time of a next-cycle CEK, and second remaining effective duration of the next-cycle CEK. The first remaining effective duration is related to the start time of the next-cycle CEK and creation time of the key update message. The second remaining effective duration is the update cycle. The start time of the next-cycle CEK is related to start time of the current CEK and the update cycle.

In some embodiments, the receiving, within effective duration of a current CEK, a key update message sent by the CCO may include: receiving, within the effective duration of the current CEK, the key update message sent by the COO for the first time when a timing reaches first preset duration; and receiving the key update message sent by the COO for the second time when the timing reaches second preset duration.

Specifically, within the effective duration of the current CEK, the STA in the power communication network can receive the key update message sent by the CCO for the first time when the timing reaches the first preset duration. When the timing reaches the first preset duration, after the key update message is sent to the multi-mode node in the power communication network for the first time, duration of the timer is modified to the second preset duration. After the timing reaches the second preset duration, the STA in the power communication network can receive the key update message sent by the CCO for the second time when the timing reaches the second preset duration.

In the above embodiments, when the first preset duration and the second preset duration are reached, the CCO can broadcast the key update message twice. By actively broadcasting the key update message, the CCO can avoid a decryption failure caused by a key update, thereby ensuring reliability, effectiveness, and smoothness of updating the CEK.

In some embodiments, the security control method may further include: if the timing reaches third preset duration, enabling a next-cycle CEK as the current CEK, where a sum of the first preset duration, the second preset duration, and the third preset duration is equal to the update cycle.

In some embodiments, the CEK is updated regularly, and the CEK corresponds to the update cycle; and the security control method may further include: sending a key request message to the CCO when the key update message is not received. The key request message is used to instruct the CCO to send the key update message.

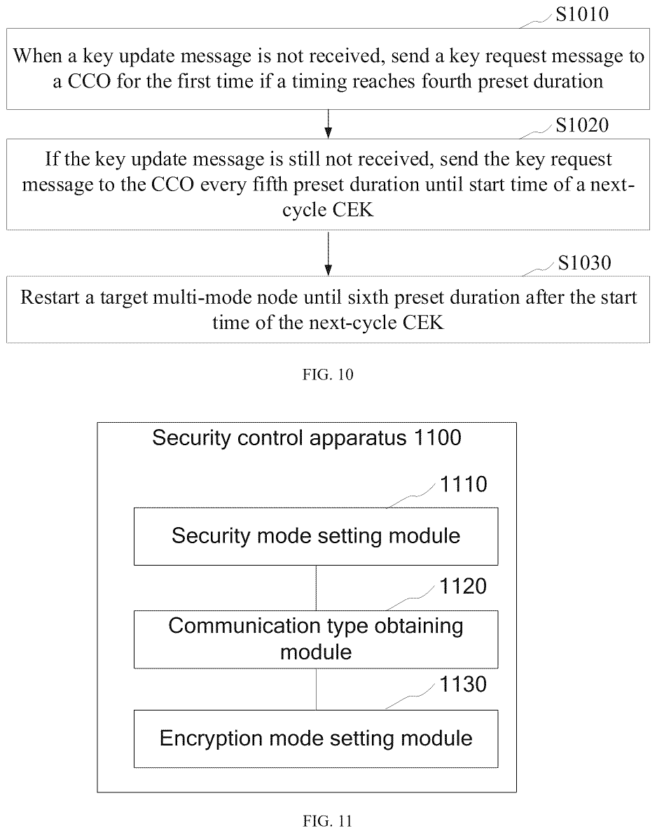

In some embodiments, referring to FIG. 10, the sending a key request message to the CCO when the key update message is not received includes following steps:

S1010: When the key update message is not received, send the key request message to the CCO for the first time if the timing reaches fourth preset duration.

S1020: If the key update message is still not received, send the key request message to the CCO every fifth preset duration until the start time of the next-cycle CEK.

S1030: Restart the target multi-mode node until sixth preset duration after the start time of the next-cycle CEK.

Specifically, if the target multi-mode node has not yet received the key update message when the timing reaches the fourth preset duration, the target multi-mode node sends the key request message to the CCO for the first time. The CCO sends the key update message to the target multi-mode node in response to the key request message of the target multi-mode node. If the target multi-mode node has not yet received the key update message, the target multi-mode node can send the key request message to the CCO every the fifth preset duration until the start time of the next-cycle CEK. If the key update message is received before the timer expires, the next-cycle CEK and remaining effective duration can be updated, and time of the timer can be changed to the start time of the next-cycle CEK. If the key update message is not received before the start time of the next-cycle CEK is reached, if the target multi-mode node has not yet received the key update message within the sixth preset duration after the start time of the next-cycle CEK, the target multi-mode node can be restarted, in other words, hardware reset, power-off, and power-on operations are performed on the target multi-mode node without network switching.

For example, if the multi-mode node in the power communication network has not yet received the key update message when ⅓ of a validity period of the current key is left or a remaining validity period of the current key is less than 20 minutes, the multi-mode node sends the key request message to the CCO. In response to the key request message sent by the STA (multi-mode node) in the power communication network, the CCO sends the key update message to the STA in the power communication network. If the STA in the power communication network has not yet received the key update message, the time of the timer is changed to 5 minutes, that is, after 5 minutes, the STA in the power communication network sends the key request message once to the CCO. If the key update message is received before the timer expires, the next-cycle CEK and the remaining effective duration can be updated, and the time of the timer can be changed to the start time of the next-cycle CEK. If the key update message is not received before the timer expires, the key request message can be sent once to the CCO every 5 minutes until current time reaches the start time of the next-cycle CEK. When the current time reaches the start time of the next-cycle CEK, the STA in the power communication network sends the key request message to the CCO, and changes the timer to 2 minutes. That is, after 2 minutes, the STA in the power communication network sends the key request message once to the CCO. If the key update message is received before the timer expires each time, the next-cycle CEK and the remaining effective duration can be updated, and the time of the timer can be changed to the start time of the next-cycle CEK. If the key update message is not received before the timer expires, the key request message can be sent once to the CCO every 2 minutes. If the key update message is still not received until the current time reaches 10 minutes after the start time of the next-cycle CEK, the STA in the power communication network is restarted, in other words, the hardware reset, power-on, and power-off operations are performed on the STA without the network switching.

In the above embodiments, if the key update message is not received, and the fourth preset duration is reached, the key request message is sent to the CCO for the first time. If the key update message is still not received, the key request message is sent to the CCO every the fifth preset duration until the start time of the next-cycle CEK. If the key update message is not received until the sixth preset duration after the start time of the next-cycle CEK, the target multi-mode node is restarted. This can avoid a decryption failure caused by a key update, and improves the reliability, the effectiveness, and the smoothness of updating the CEK.

In some embodiments, the security control method may further include: if there is to-be-sent business data in the encrypted mode, determining a data type of the to-be-sent business data and a security mode of a destination node; and selecting a corresponding key type from the CMK or the CEK based on the data type of the to-be-sent business data and the security mode of the destination node to encrypt the to-be-sent business data.

Specifically, when there is the to-be-sent business data in the encrypted mode, the data type of the to-be-sent business data and the security mode of the destination node can be determined. When the security mode of the destination node is not enabled, the to-be-sent business data does not need to be encrypted, and can be directly sent to the destination node. When the security mode of the destination node is enabled, the corresponding key type can be selected from the CMK or the CEK based on the data type of the to-be-sent business data and the security mode of the destination node to encrypt the to-be-sent business data.

In the above embodiments, whether the to-be-sent business data needs to be encrypted can be determined by determining the data type of the to-be-sent business data and the security mode of the destination node. This can reduce consumption of computer resources.

In some embodiments, the to-be-sent business data includes an MSDU data frame; and the security control method may further include: determining an IV based on a MAC frame type; and encrypting the MSDU data frame based on the IV and the selected key type to obtain corresponding ciphertext, and sending the ciphertext.

Specifically, the IV can be determined based on the MAC frame type, and a method for encrypting the MSDU data frame can be selected. Different encryption methods may require IVs containing different bits. When the MSDU data frame is encrypted by the selected encryption method, the MSDU data frame is encrypted by the selected key type and an IV of a bit quantity corresponding to the selected encryption method, to obtain the corresponding ciphertext, and the ciphertext is sent to a receiver.

In the above embodiments, the IV is determined based on the MAC frame type; and the MSDU data frame is encrypted based on the IV and the selected key type to obtain the corresponding ciphertext, and the ciphertext is sent. In an MSDU data transmission process, a data encryption process is designed to ensure transmission reliability of the to-be-sent business data.

In some embodiments, the security control method may further include: if received business data is encrypted, determining whether the key type is the CMK or the CEK; and if the key type is the CMK, decrypting the data by the CMK and the IV, to obtain plaintext corresponding to the received business data; or if the key type is the CEK, decrypting the data by the CEK and the IV, to obtain plaintext corresponding to the received business data.

Specifically, based on a MAC frame header stored in the business data, the business data receiver can determine whether the received business data is encrypted. If information data stored in the MAC frame header indicates that the received business data is encrypted, it can be determined that the received business data is encrypted. Then, the key type corresponding to the received business data can be directly determined based on the key type stored in the MAC frame header. When the key type is the CMK, the IV can be determined based on the MAC frame type, and a corresponding decryption method can be determined based on the method for encrypting the MSDU data frame. Different decryption methods may require IVs containing different bits. When the decryption method is used for decryption, if the key type is the CMK, the data is decrypted by the CMK and the IV, to obtain the plaintext corresponding to the received business data. If the key type is the CEK, the data is decrypted by the CEK and the IV, to obtain the plaintext corresponding to the received business data.

In the above embodiments, if the received business data is encrypted, whether the key type is the CMK or the CEK is determined. If the key type is the CMK, the data is decrypted by the CMK and the IV, to obtain the corresponding plaintext. If the key type is the CEK, the data is decrypted by the CEK and the IV, to obtain the corresponding plaintext. Different decryption methods can be determined based on different key types, MAC frame types, and encryption methods, which can improve security of the business data.

In some embodiments, an implementation of the specification provides a security control apparatus for a power communication network, which is applied to a CCO included in the power communication network. Referring to FIG. 11, the security control apparatus 1100 includes:
a security mode setting module 1110 configured to set a security mode of the power communication network to an unencrypted mode;
a communication type obtaining module 1120 configured to obtain a communication type of a STA upon receiving a first network access request sent by the STA; and
an encryption mode setting module 1130 configured to set the security mode of the power communication network to an encrypted mode if it is determined based on the communication type of the STA and a corresponding node type list of the power communication network that there is a multi-mode node in the power communication network, where the node type list stores a communication type of a STA that has been connected to the power communication network.

In some embodiments, the security control apparatus further includes:
a mode keeping module configured to keep the security mode of the power communication network to be the unencrypted mode if it is determined based on the communication type of the STA and the corresponding node type list of the power communication network that all STAs in the power communication network are single-mode nodes.

In some embodiments, the encryption mode setting module is further configured to: if it is determined based on the communication type of the STA and the corresponding node type list of the power communication network that there is both the single-mode node and the multi-mode node in the power communication network, set the security mode of the power communication network to a compatible mode, where in the compatible mode, an application layer message transmitted by the multi-mode node needs to be encrypted, and the multi-mode node is a STA based on at least two communication modes: HPLC and HRF communication; or if it is determined based on the communication type of the STA and the corresponding node type list of the power communication network that all the STAs in the power communication network are multi-mode nodes, set the security mode of the power communication network to a forced mode, where in the forced mode, other messages than a transformer area identification message need to be encrypted.

In some embodiments, the security control apparatus further includes:
a network access request receiving module configured to: after the security mode is set to the compatible mode, receive a second network access request sent by the STA in the power communication network in the compatible mode, to perform re-networking; or after the security mode is set to the forced mode, receive a second network access request sent by the STA in the power communication network in the forced mode, to perform re-networking.

In some embodiments, the security control apparatus further includes:
a communication type recording module configured to record the communication type of the STA in the corresponding node type list of the power communication network.

In some embodiments, the security control apparatus further includes:
a beacon broadcasting module configured to broadcast a beacon, where the beacon carries an authentication enabling flag, and the beacon is used to instruct a target multi-mode node that has not yet been connected to the network to determine a current encryption mode based on the authentication enabling flag, and send identity authentication information corresponding to the current encryption mode to the CCO;
a multi-mode request receiving module configured to receive a second network access request from the target multi-mode node, where the second network access request carries the identity authentication information; and
an authentication information determining module configured to determine, based on the identity authentication information, whether to send a CMK and a CEK to the target multi-mode node.

In some embodiments, the identity authentication information includes a first random number, a MAC address of the target multi-mode node, and first certificate data; and the authentication information determining module is further configured to: if the MAC address of the target multi-mode node is in a network access whitelist of the CCO and the first certificate data is verified to be valid, encrypt the first random number by a private key of the CCO; extract first public key information from the first certificate data, and encrypt the CMK based on the extracted first public key information; and send the encrypted first random number, the encrypted CMK, and second certificate data of the CCO to the target multi-mode node, such that when the second certificate data is verified to be valid and the encrypted first random number passes signature verification, the target multi-mode node decrypts the encrypted CMK by a private key of the target multi-mode node, and saves the decrypted CMK.

In some embodiments, the authentication information determining module is further configured to: receive an association request sent by the target multi-mode node, where the association request carries the MAC address that is of the target multi-mode node and encrypted by the CMK; decrypt, by the CMK, the MAC address encrypted by the CMK, to obtain the decrypted MAC address of the target multi-mode node; and if the decrypted MAC address of the target multi-mode node is consistent with the MAC address included in the identity authentication information, send an association confirmation message to the target multi-mode node, where the association confirmation message is used to instruct the target multi-mode node to complete network access and save the CEK carried in the association confirmation message.

In some embodiments, the security control apparatus includes:
an encryption key encrypting module configured to encrypt the CEK by the CMK, to obtain the encrypted CEK, where the association confirmation message carries the encrypted CEK, and the association confirmation message is used to instruct the target multi-mode node to decrypt the encrypted CEK by the CMK, to obtain and save the CEK.

In some embodiments, the security control apparatus includes:
an association failure sending module configured to: if the decrypted MAC address of the target multi-mode node is inconsistent with the MAC address included in the identity authentication information, send an association failure message to the target multi-mode node, where the association failure message is used to notify the target multi-mode node that the CMK is incorrect.

In some embodiments, the identity authentication information includes the first random number, the MAC address of the target multi-mode node, and the first certificate data; and
the authentication information determining module is further configured to: if the MAC address of the target multi-mode node is not in the network access whitelist of the CCO, or if the MAC address of the target multi-mode node is in a network access blacklist of the CCO, send a network access rejection message to the target multi-mode node; and if the first certificate data is verified to be invalid, add the MAC address of the target multi-mode node to the network access blacklist of the CCO, and send the network access rejection message to the target multi-mode node.

In some embodiments, the CEK is updated regularly, and the CEK corresponds to an update cycle; and the security control apparatus further includes:
an update message sending module configured to send a key update message to the multi-mode node in the power communication network within effective duration of a current CEK, where the key update message includes first remaining effective duration of the current CEK, start time of a next-cycle CEK, and second remaining effective duration of the next-cycle CEK; the first remaining effective duration is related to the start time of the next-cycle CEK and creation time of the key update message; the second remaining effective duration is the update cycle; and the start time of the next-cycle CEK is related to start time of the current CEK and the update cycle.

In some embodiments, the update message sending module is further configured to: if a timing reaches first preset duration within the effective duration of the current CEK, send the key update message to the multi-mode node in the power communication network for the first time; and if the timing reaches second preset duration, send the key update message to the multi-mode node in the power communication network for the second time.

In some embodiments, the security control apparatus further includes:
a next key enabling module configured to: if the timing reaches third preset duration, enable the next-cycle CEK as the current CEK, where a sum of the first preset duration, the second preset duration, and the third preset duration is equal to the update cycle.

In some embodiments, the CEK is updated regularly, and the CEK corresponds to the update cycle; and the security control apparatus further includes:
a key request receiving module configured to: when the multi-mode node in the power communication network does not receive the key update message, receive a key request message sent by the multi-mode node in the power communication network; and
a key update sending module configured to send the key update message to the multi-mode node in the power communication network based on the key request message.

In some embodiments, the key request message carries a sequence number of a current request; and the key update sending module is further configured to: if the sequence number of the current request is consistent with a sequence number of the next-cycle CEK, send a first key update message to the multi-mode node in the power communication network, where the first key update message includes the start time, second remaining effective duration, and a countdown of the next-cycle CEK; the countdown is related to the start time of the next-cycle CEK and the creation time of the key update message; the second remaining effective duration is the update cycle; and the start time of the next-cycle CEK is related to the start time of the current CEK and the update cycle.

In some embodiments, the key request message carries a sequence number of a current request; and the key update sending module is further configured to: if the sequence number of the current request is inconsistent with a sequence number of the next-cycle CEK, send a second key update message to the multi-mode node in the power communication network, where the second key update message includes the first remaining effective duration of the current CEK; and the first remaining effective duration is related to the start time of the next-cycle CEK and the creation time of the key update message.

In some embodiments, an implementation of the specification provides a security control apparatus for a power communication network, which is applied to a STA included in the power communication network. The security control apparatus includes:
a network access request sending module configured to send a first network access request to a CCO included in the power communication network when a security mode of the power communication network is an unencrypted mode, where the first network access request carries a communication type of the STA; the first network access request is used to instruct the CCO to set the security mode of the power communication network, where if it is determined based on the communication type of the STA and a corresponding node type list of the power communication network that there is a multi-mode node in the power communication network, the CCO sets the security mode to an encrypted mode, where the node type list stores a communication type of a STA that has been connected to the power communication network.

In some embodiments, the security control apparatus for a power communication network includes a processor. The processor is configured to execute the foregoing program modules stored in a memory, including the security mode setting module 1110, the communication type obtaining module 1120, the encryption mode setting module 1130, the mode keeping module, the network access request receiving module, the communication type recording module, the beacon broadcasting module, the multi-mode request receiving module, the authentication information determining module, the encryption key encrypting module, the association failure sending module, the update message sending module, the next key enabling module, the key request receiving module, the key update sending module, and the network access request sending module.

For specific description of the security control apparatus for a power communication network, reference may be made to the description of the security control method for a power communication network in the previous text, and details are not described herein again.

In some embodiments, an implementation of the specification provides a CCO, including a transceiver, a processor, and a memory. The memory is configured to store a computer program, and the processor is configured to call the computer program to perform the steps of the method in the above embodiments.

In some embodiments, an implementation of the specification provides a STA, including a transceiver, a processor, and a memory. The memory is configured to store a computer program, and the processor is configured to call the computer program to perform the steps of the method in the above embodiments.

An implementation of the specification provides a computer-readable storage medium that stores a computer program. The computer program is executed by a processor to implement the steps of the method in any one of the above embodiments.

An implementation of the specification provides a computer program product. The computer program product includes an instruction. When the instruction is executed by a processor of a computer device, the computer device is enabled to perform the steps of the method in any one of the above embodiments.

It should be noted that logic and/or steps shown in the flowcharts or described herein in other manners, for example, may be considered as a program list of executable instructions that are used to implement logical functions, and may be specifically implemented on any computer-readable medium, for an instruction execution system, apparatus, or device (for example, a computer-based system, a system including a processor, or another system that can fetch instructions from the instruction execution system, apparatus, or device and execute the instructions) to use, or for a combination of the instruction execution system, apparatus, or device to use. In terms of this specification, the “computer-readable medium” may be any apparatus that may include, store, communicate, propagate, or transmit programs, for the instruction execution system, apparatus, or device to use, or for a combination of the instruction execution system, apparatus, or device to use. More specific examples (this list is not exhaustive) of the computer-readable medium include the following: an electrical connection portion (an electrical apparatus) with one or more buses, a portable computer cartridge (a magnetic apparatus), a random-access memory (RAM), a read-only memory (ROM), an erasable programmable read-only memory (EPROM or flash memory), an optical fiber apparatus, and a compact disc read-only memory (CD-ROM). In addition, the computer-readable medium may even be a piece of paper on which the programs can be printed or another appropriate medium, because, for example, optical scanning may be performed on the paper or the another medium, then processing, such as edition, decoding, or another appropriate means when necessary, may be performed to obtain the programs in an electronic manner, and then the programs are stored in a computer memory.

It should be understood that each part of the present disclosure may be implemented by hardware, software, firmware, or a combination thereof. In the above embodiments, a plurality of steps or methods may be implemented by software or firmware that is stored in a memory and that is executed by a proper instruction execution system. For example, if implemented by hardware, as in another implementation, this implementation may be implemented by any one or a combination of the following technologies known in the art: a discrete logic circuit with a logic gate circuit for implementing a logical function on a data signal, an application-specific integrated circuit with a suitable combinational logic gate circuit, a programmable gate array (PGA), a field programmable gate array (FPGA), and the like.

In this specification, descriptions of reference terms such as “one embodiment”, “some embodiments”, “an example”, “a specific example”, and “some examples” indicate that specific features, structures, materials, or characteristics described in combination with the embodiment(s) or example(s) are included in at least one embodiment or example of the present disclosure. In this specification, the schematic representations of the above terms do not necessarily refer to the same embodiment or example. In addition, the specific features, structures, materials, or characteristics described may be combined in any suitable manner in any one or more embodiments or examples.

In addition, the terms “first” and “second” are merely intended for a purpose of description, and shall not be understood as an indication or implication of relative importance or implicit indication of a quantity of indicated technical features. Therefore, a feature limited by “first” or “second” may explicitly or implicitly include at least one such feature. In the descriptions about the present disclosure, “a plurality of” means at least two, for example, two or three, unless otherwise specifically limited.

In the present disclosure, unless otherwise clearly limited, the terms “installation”, “interconnection”, “connection” and “fixation” etc. are intended to be understood in a broad sense. For example, the “connection” may be a fixed connection, a removable connection or an integral connection; may be a mechanical connection or an electrical connection; may be a direct connection or an indirect connection using an intermediate medium; and may be a communication or an interaction between two elements, unless otherwise clearly specified and limited. Those of ordinary skill in the art may understand specific meanings of the above terms in the present disclosure based on a specific situation.

Although the embodiments of the present disclosure have been illustrated and described above, it will be appreciated that the above embodiments are illustrative and should not be construed as limitations to the present disclosure. Changes, modifications, substitutions, and variations can be made to the above embodiments by a person of ordinary skill in the art within the scope of the present disclosure.

1. A security control method for a power communication network, applied to a central coordinator (CCO) comprised in the power communication network, wherein the security control method comprises:
setting a security mode of the power communication network to an unencrypted mode;
obtaining a communication type of a station (STA) upon receiving a first network access request sent by the STA; and
setting the security mode of the power communication network to an encrypted mode when determining, based on the communication type of the STA and a corresponding node type list of the power communication network, that there is a multi-mode node in the power communication network, wherein the node type list stores a communication type of a STA that has been connected to the power communication network.

2. The security control method according to claim 1, further comprising:
keeping the security mode of the power communication network to be the unencrypted mode when determining, based on the communication type of the STA and the corresponding node type list of the power communication network, that all STAs in the power communication network are single-mode nodes, wherein the single-mode node is a STA based on high-speed power line communication (HPLC).

3. The security control method according to claim 1, wherein the setting the security mode of the power communication network to an encrypted mode when determining, based on the communication type of the STA and a corresponding node type list of the power communication network, that there is a multi-mode node in the power communication network comprises at least one of following cases:
when determining, based on the communication type of the STA and the corresponding node type list of the power communication network, that there is both a single-mode node and a multi-mode node in the power communication network, setting the security mode of the power communication network to a compatible mode, wherein in the compatible mode, an application layer message transmitted by the multi-mode node is encrypted, and the multi-mode node is a STA based on at least two communication modes: HPLC and high-speed radio frequency (HRF) communication; and
when determining, based on the communication type of the STA and the corresponding node type list of the power communication network, that all STAs in the power communication network are multi-mode nodes, setting the security mode of the power communication network to a forced mode, wherein in the forced mode, other messages than a transformer area identification message are encrypted.

4. The security control method according to claim 3, further comprising at least one of following cases:
after setting the security mode to the compatible mode, receiving a second network access request sent by the STA in the power communication network in the compatible mode, to perform re-networking; or
after setting the security mode to the forced mode, receiving a second network access request sent by the STA in the power communication network in the forced mode, to perform re-networking.

5. The security control method according to claim 1, wherein after the obtaining a communication type of a STA, the security control method further comprises:
recording the communication type of the STA in the corresponding node type list of the power communication network.

6. The security control method according to claim 1, further comprising:
broadcasting a beacon, wherein the beacon carries an authentication enabling flag, and the beacon is used to instruct a target multi-mode node that has not yet been connected to the network to determine a current encryption mode based on the authentication enabling flag, and send identity authentication information corresponding to the current encryption mode to the CCO;
receiving a second network access request from the target multi-mode node, wherein the second network access request carries the identity authentication information; and
determining, based on the identity authentication information, whether to send a customer master key (CMK) and a contents encrypting key (CEK) to the target multi-mode node.

7. The security control method according to claim 6, wherein the identity authentication information comprises a first random number, a media access control (MAC) address of the target multi-mode node, and first certificate data, and the determining, based on the identity authentication information, whether to send a CMK and a CEK to the target multi-mode node comprises:
when the MAC address of the target multi-mode node is in a network access whitelist of the CCO and the first certificate data is verified to be valid, encrypting the first random number by a private key of the CCO; extracting first public key information from the first certificate data, and encrypting the CMK based on the extracted first public key information; and sending the encrypted first random number, the encrypted CMK, and second certificate data of the CCO to the target multi-mode node, to enable the target multi-mode node to decrypt the encrypted CMK by a private key of the target multi-mode node, and save the decrypted CMK, when the second certificate data is verified to be valid and the encrypted first random number passes signature verification.

8. The security control method according to claim 7, wherein the determining, based on the identity authentication information, whether to send a CMK and a CEK to the target multi-mode node comprises:
receiving an association request sent by the target multi-mode node, wherein the association request carries the MAC address that is of the target multi-mode node and encrypted by the CMK;
decrypting, by the CMK, the MAC address encrypted by the CMK, to obtain the decrypted MAC address of the target multi-mode node; and
when the decrypted MAC address of the target multi-mode node is consistent with the MAC address comprised in the identity authentication information, sending an association confirmation message to the target multi-mode node, wherein the association confirmation message is used to instruct the target multi-mode node to complete network access and save the CEK carried in the association confirmation message.

9. The security control method according to claim 8, wherein before the sending an association confirmation message to the target multi-mode node, the security control method further comprises:
encrypting the CEK by the CMK, to obtain the encrypted CEK, wherein the association confirmation message carries the encrypted CEK, and the association confirmation message is used to instruct the target multi-mode node to decrypt the encrypted CEK by the CMK, to obtain and save the CEK.

10. The security control method according to claim 8, further comprising:
when the decrypted MAC address of the target multi-mode node is inconsistent with the MAC address comprised in the identity authentication information, sending an association failure message to the target multi-mode node, wherein the association failure message is used to notify the target multi-mode node that the CMK is incorrect.

11. The security control method according to claim 7, wherein the identity authentication information comprises the first random number, the MAC address of the target multi-mode node, and the first certificate data, and the determining, based on the identity authentication information, whether to send a CMK and a CEK to the target multi-mode node comprises:
when the MAC address of the target multi-mode node is not in the network access whitelist of the CCO, or when the MAC address of the target multi-mode node is in a network access blacklist of the CCO, sending a network access rejection message to the target multi-mode node; and
when the first certificate data is verified to be invalid, adding the MAC address of the target multi-mode node to the network access blacklist of the CCO, and sending the network access rejection message to the target multi-mode node.

12. The security control method according to claim 7, wherein a process of verifying the first certificate data comprises:
verifying a signature in the first certificate data by a root public key provided by a third party; and
when the signature in the first certificate data is correct, determining that the first certificate data is valid; or
when the signature in the first certificate data is incorrect, determining that the first certificate data is invalid.

13. The security control method according to claim 6, wherein the CEK is updated regularly, and the CEK corresponds to an update cycle; and the security control method further comprises:
sending a key update message to the multi-mode node in the power communication network within effective duration of a current CEK, wherein the key update message comprises first remaining effective duration of the current CEK, start time of a next-cycle CEK, and second remaining effective duration of the next-cycle CEK; the first remaining effective duration is related to the start time of the next-cycle CEK and creation time of the key update message; the second remaining effective duration is the update cycle; and the start time of the next-cycle CEK is related to start time of the current CEK and the update cycle.

14. The security control method according to claim 13, wherein the sending a key update message to the multi-mode node in the power communication network within effective duration of a current CEK comprises:
when a timing reaches first preset duration within the effective duration of the current CEK, sending the key update message to the multi-mode node in the power communication network for the first time; and
when the timing reaches second preset duration, sending the key update message to the multi-mode node in the power communication network for the second time.

15. The security control method according to claim 14, further comprising:
when the timing reaches third preset duration, enabling the next-cycle CEK as the current CEK, wherein a sum of the first preset duration, the second preset duration, and the third preset duration is equal to the update cycle.

16. The security control method according to claim 13, wherein the CEK is updated regularly, and the CEK corresponds to the update cycle; and the security control method further comprises:
receiving a key request message sent by the multi-mode node in the power communication network when the multi-mode node in the power communication network does not receive the key update message; and
sending the key update message to the multi-mode node in the power communication network based on the key request message.

17. The security control method according to claim 16, wherein the key request message carries a sequence number of a current request; and the sending the key update message to the multi-mode node in the power communication network based on the key request message comprises:
when the sequence number of the current request is consistent with a sequence number of the next-cycle CEK, sending a first key update message to the multi-mode node in the power communication network, wherein the first key update message comprises the start time, the second remaining effective duration, and a countdown of the next-cycle CEK; the countdown is related to the start time of the next-cycle CEK and the creation time of the key update message; the second remaining effective duration is the update cycle; and the start time of the next-cycle CEK is related to the start time of the current CEK and the update cycle.

18. The security control method according to claim 16, wherein the key request message carries a sequence number of a current request; and the sending the key update message to the multi-mode node in the power communication network based on the key request message comprises:
when the sequence number of the current request is inconsistent with a sequence number of the next-cycle CEK, sending a second key update message to the multi-mode node in the power communication network, wherein the second key update message comprises the first remaining effective duration of the current CEK; and the first remaining effective duration is related to the start time of the next-cycle CEK and the creation time of the key update message.

19. The security control method according to claim 1, further comprising:
when there is to-be-sent business data in the encrypted mode, determining a data type of the to-be-sent business data and a security mode of a destination node; and
selecting a corresponding key type from a CMK or a CEK based on the data type of the to-be-sent business data and the security mode of the destination node.

20. The security control method according to claim 19, wherein when the security mode of the destination node is a forced mode, the selecting a corresponding key type from a CMK or a CEK based on the data type of the to-be-sent business data and the security mode of the destination node comprises:
when the data type of the to-be-sent business data belongs to a first type set, selecting the CMK to encrypt the to-be-sent business data, wherein the first type set comprises at least one of an association request, an association confirmation message, an association summarization message, a key update message, a key request message, and a key request confirmation message; or
when the data type of the to-be-sent business data belongs to a second type set, selecting the CEK to encrypt the to-be-sent business data, wherein the second type set comprises an application layer message.

21. The security control method according to claim 19, wherein when the security mode of the destination node is a compatible mode, the selecting a corresponding key type from a CMK or a CEK based on the data type of the to-be-sent business data and the security mode of the destination node comprises:
when the destination node is a multi-mode node and the data type of the to-be-sent business data belongs to an application layer message, selecting the CEK to encrypt the to-be-sent business data;
when the destination node is a multi-mode node and the data type of the to-be-sent business data does not belong to an application layer message, skipping encrypting the to-be-sent business data; or
when the destination node is a single-mode node, skipping encrypting the to-be-sent business data.

22. The security control method according to claim 19, wherein the to-be-sent business data comprises a MAC service data unit (MSDU) data frame; and the security control method further comprises:
determining an initialization vector (IV) based on a MAC frame type; and
encrypting the MSDU data frame based on the IV and the selected key type to obtain corresponding ciphertext, and sending the ciphertext to the destination node.

23. The security control method according to claim 22, further comprising:
when received business data is encrypted, determining whether the key type is the CMK or the CEK; and
when the key type is the CMK, decrypting the received business data by the CMK and the IV, to obtain corresponding plaintext; or
when the key type is the CEK, decrypting the received business data by the CEK and the IV, to obtain corresponding plaintext.

24. The security control method according to claim 23, further comprising:
when the decryption fails, sending a decryption failure response message to a node that received the business data.

25. A security control method for a power communication network, applied to a STA comprised in the power communication network, wherein the security control method comprises:
sending a first network access request to a CCO comprised in the power communication network when a security mode of the power communication network is an unencrypted mode, wherein the first network access request carries a communication type of the STA; the first network access request is used to instruct the CCO to set the security mode of the power communication network, wherein when it is determined based on the communication type of the STA and a corresponding node type list of the power communication network that there is a multi-mode node in the power communication network, the CCO sets the security mode to an encrypted mode, wherein the node type list stores a communication type of a STA that has been connected to the power communication network.

26. A security control apparatus for a power communication network, applied to a CCO comprised in the power communication network, wherein the security control apparatus comprises:
a security mode setting module configured to set a security mode of the power communication network to an unencrypted mode;
a communication type obtaining module configured to obtain a communication type of a STA upon receiving a first network access request sent by the STA; and
an encryption mode setting module configured to set the security mode of the power communication network to an encrypted mode when it is determined based on the communication type of the STA and a corresponding node type list of the power communication network that there is a multi-mode node in the power communication network, wherein the node type list stores a communication type of a STA that has been connected to the power communication network.

27. The security control apparatus according to claim 26, further comprising:
a mode keeping module configured to keep the security mode of the power communication network to be the unencrypted mode when it is determined based on the communication type of the STA and the corresponding node type list of the power communication network that all STAs in the power communication network are single-mode nodes, wherein the single-mode node is a STA based on HPLC.

28. The security control apparatus according to claim 26, wherein the encryption mode setting module is further configured to: when it is determined based on the communication type of the STA and the corresponding node type list of the power communication network that there is both a single-mode node and a multi-mode node in the power communication network, set the security mode of the power communication network to a compatible mode, wherein in the compatible mode, an application layer message transmitted by the multi-mode node is encrypted, and the multi-mode node is a STA based on at least two communication modes: HPLC and HRF communication; or when it is determined based on the communication type of the STA and the corresponding node type list of the power communication network that all STAs in the power communication network are multi-mode nodes, set the security mode of the power communication network to a forced mode, wherein in the forced mode, other messages than a transformer area identification message are encrypted.

29. The security control apparatus according to claim 28, further comprising:
a network access request receiving module configured to: after the security mode is set to the compatible mode, receive a second network access request sent by the STA in the power communication network in the compatible mode, to perform re-networking; or after the security mode is set to the forced mode, receive a second network access request sent by the STA in the power communication network in the forced mode, to perform re-networking.

30. The security control apparatus according to claim 26, further comprising:
a communication type recording module configured to record the communication type of the STA in the corresponding node type list of the power communication network.

31. The security control apparatus according to claim 26, further comprising:
a beacon broadcasting module configured to broadcast a beacon, wherein the beacon carries an authentication enabling flag, and the beacon is used to instruct a target multi-mode node that has not yet been connected to the network to determine a current encryption mode based on the authentication enabling flag, and send identity authentication information corresponding to the current encryption mode to the CCO;
a multi-mode request receiving module configured to receive a second network access request from the target multi-mode node, wherein the second network access request carries the identity authentication information; and
an authentication information determining module configured to determine, based on the identity authentication information, whether to send a CMK and a CEK to the target multi-mode node.

32. The security control apparatus according to claim 31, wherein the identity authentication information comprises a first random number, a MAC address of the target multi-mode node, and first certificate data; and the authentication information determining module is further configured to: when the MAC address of the target multi-mode node is in a network access whitelist of the CCO and the first certificate data is verified to be valid, encrypt the first random number by a private key of the CCO; extract first public key information from the first certificate data, and encrypt the CMK based on the extracted first public key information; and send the encrypted first random number, the encrypted CMK, and second certificate data of the CCO to the target multi-mode node, to enable the target multi-mode node to decrypt the encrypted CMK by a private key of the target multi-mode node, and save the decrypted CMK, when the second certificate data is verified to be valid and the encrypted first random number passes signature verification.

33. The security control apparatus according to claim 32, wherein the authentication information determining module is further configured to: receive an association request sent by the target multi-mode node, wherein the association request carries the MAC address that is of the target multi-mode node and encrypted by the CMK; decrypt, by the CMK, the MAC address encrypted by the CMK, to obtain the decrypted MAC address of the target multi-mode node; and when the decrypted MAC address of the target multi-mode node is consistent with the MAC address comprised in the identity authentication information, send an association confirmation message to the target multi-mode node, wherein the association confirmation message is used to instruct the target multi-mode node to complete network access and save the CEK carried in the association confirmation message.

34. The security control apparatus according to claim 33, further comprising:
an encryption key encrypting module configured to encrypt the CEK by the CMK, to obtain the encrypted CEK, wherein the association confirmation message carries the encrypted CEK, and the association confirmation message is used to instruct the target multi-mode node to decrypt the encrypted CEK by the CMK, to obtain and save the CEK.

35. The security control apparatus according to claim 33, further comprising:
an association failure sending module configured to: when the decrypted MAC address of the target multi-mode node is inconsistent with the MAC address comprised in the identity authentication information, send an association failure message to the target multi-mode node, wherein the association failure message is used to notify the target multi-mode node that the CMK is incorrect.

36. The security control apparatus according to claim 32, wherein the identity authentication information comprises the first random number, the MAC address of the target multi-mode node, and the first certificate data; and
the authentication information determining module is further configured to: when the MAC address of the target multi-mode node is not in the network access whitelist of the CCO, or when the MAC address of the target multi-mode node is in a network access blacklist of the CCO, send a network access rejection message to the target multi-mode node; and when the first certificate data is verified to be invalid, add the MAC address of the target multi-mode node to the network access blacklist of the CCO, and send the network access rejection message to the target multi-mode node.

37. The security control apparatus according to claim 31, wherein the CEK is updated regularly, and the CEK corresponds to an update cycle; and the security control apparatus further comprises:
an update message sending module configured to send a key update message to the multi-mode node in the power communication network within effective duration of a current CEK, wherein the key update message comprises first remaining effective duration of the current CEK, start time of a next-cycle CEK, and second remaining effective duration of the next-cycle CEK; the first remaining effective duration is related to the start time of the next-cycle CEK and creation time of the key update message; the second remaining effective duration is the update cycle; and the start time of the next-cycle CEK is related to start time of the current CEK and the update cycle.

38. The security control apparatus according to claim 37, wherein the update message sending module is further configured to: when a timing reaches first preset duration within the effective duration of the current CEK, send the key update message to the multi-mode node in the power communication network for the first time; and when the timing reaches second preset duration, send the key update message to the multi-mode node in the power communication network for the second time.

39. The security control apparatus according to claim 38, further comprising:
a next key enabling module configured to: when the timing reaches third preset duration, enable the next-cycle CEK as the current CEK, wherein a sum of the first preset duration, the second preset duration, and the third preset duration is equal to the update cycle.

40. The security control apparatus according to claim 37, wherein the CEK is updated regularly, and the CEK corresponds to the update cycle; and the security control apparatus further comprises:
a key request receiving module configured to: when the multi-mode node in the power communication network does not receive the key update message, receive a key request message sent by the multi-mode node in the power communication network; and
a key update sending module configured to send the key update message to the multi-mode node in the power communication network based on the key request message.

41. The security control apparatus according to claim 40, wherein the key request message carries a sequence number of a current request; and the key update sending module is further configured to: when the sequence number of the current request is consistent with a sequence number of the next-cycle CEK, send a first key update message to the multi-mode node in the power communication network, wherein the first key update message comprises the start time, the second remaining effective duration, and a countdown of the next-cycle CEK; the countdown is related to the start time of the next-cycle CEK and the creation time of the key update message; the second remaining effective duration is the update cycle; and the start time of the next-cycle CEK is related to the start time of the current CEK and the update cycle.

42. The security control apparatus according to claim 40, wherein the key request message carries a sequence number of a current request; and the key update sending module is further configured to: when the sequence number of the current request is inconsistent with a sequence number of the next-cycle CEK, send a second key update message to the multi-mode node in the power communication network, wherein the second key update message comprises the first remaining effective duration of the current CEK; and the first remaining effective duration is related to the start time of the next-cycle CEK and the creation time of the key update message.

43. A security control apparatus for a power communication network, applied to a STA comprised in the power communication network, wherein the security control apparatus comprises:
a network access request sending module configured to send a first network access request to a CCO comprised in the power communication network when a security mode of the power communication network is an unencrypted mode, wherein the first network access request carries a communication type of the STA; the first network access request is used to instruct the CCO to set the security mode of the power communication network, wherein when it is determined based on the communication type of the STA and a corresponding node type list of the power communication network that there is a multi-mode node in the power communication network, the CCO sets the security mode to an encrypted mode, wherein the node type list stores a communication type of a STA that has been connected to the power communication network.

44. A CCO, comprising a transceiver, a processor, and a memory, wherein the memory is configured to store a computer program, and the processor is configured to call the computer program to perform the method according to claim 1.

45. A STA, comprising a transceiver, a processor, and a memory, wherein the memory is configured to store a computer program, and the processor is configured to call the computer program to perform the method according to claim 25.

46. A computer-readable storage medium, storing a computer program, wherein the computer program is executed by a processor to implement the method according to claim 1.
